(19) United States
(12) Patent Application Publication
(10) Pub. No.: US 2026/0267829 A1
(43) Pub. Date: Sep. 10, 2026

(54) Automatic Generation of Schemas and Attributes for Geographic Locations

(71) Applicant: Google LLC, Mountain View, CA (US)

(72) Inventors: Jinyang Yu, Irvine, CA (US); Nils Roland Barth, New York, NY (US); Rui Huang, Jersey City, CA (US); Yifan Pei, San Jose, CA (US); Bo Lin, Mountain View, CA (US)

(21) Appl. No.: 19/073,839

(22) Filed: Mar. 7, 2025

(51) Int. Cl. G06F 16/21; G06F 16/2457

(52) U.S. Cl. CPC G06F 16/211; G06F 16/24578

(57) ABSTRACT

Methods, systems, devices, and non-transitory computer readable media for determining schemas and generating attributes are provided. The disclosed technology can include receiving schema data comprising web content and queries. Based on inputting the schema data into machine-learned models, schemas associated with the schema data can be determined. The machine-learned models can be configured to determine the schemas based on recognition of semantic features of the schema data. Based on the schemas, content data comprising content can be retrieved. Based on inputting the content data and the schemas into the machine-learned models, attributes associated with content verticals of the content data can be determined. Based on inputting the attributes associated with the content data into the machine-learned models, evaluated attributes comprising the attributes that satisfy evaluation criteria associated with a validity of the attributes can be determined. Furthermore, attribute data based on the evaluated attributes can be generated.

### FIELD

The present disclosure relates generally to determining schemas and generating attributes associated with content associated with geographic locations. More particularly, the present disclosure relates to implementing machine-learned models that can be used to automatically determine schemas and generate attributes associated with geographic locations.

### BACKGROUND

Searching and retrieving different types of data can be performed in a variety of ways. Further, the effectiveness of a search algorithm can be associated with the relevance of the search results that are provided. In some instances, the relevance of search results can be less than optimal, which may result in the excessive use of time and computational resources. For example, searches for the availability of certain amenities at a location can result in results that are not applicable to that class of location. Further, some search results may include relevant results that are applicable to broader queries, while being less responsive to more niche queries. Further, narrower search results may require manual intervention and be more difficult to generate, due to being buried in a larger quantity of broader and less relevant results. Additionally, excessive searching or the filtering of less relevant results may result in the consumption of greater amounts of time and computing resources. As a result, attempts to improve the effectiveness of search services and applications may present challenges. Accordingly, there may be different approaches to the search and retrieval of data.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method of generating attributes associated with geographic locations. The computer-implemented method can comprise receiving, by a computing system comprising one or more processors, schema data comprising web content and a plurality of queries. The computer-implemented method can comprise determining, by the computing system, based on inputting the schema data into one or more machine-learned models, a plurality of schemas comprising one or more attributes of geographic locations associated with the schema data. The one or more machine-learned models can be configured to determine the plurality of schemas based on recognition of one or more semantic features of the schema data. The computer-implemented method can comprise retrieving, by the computing system, based on inputting the plurality of schemas into the one or more machine-learned models, content data comprising content from one or more content sources. The computer-implemented method can comprise determining, by the computing system, based on inputting the content data and the plurality of schemas into the one or more machine-learned models, the one or more attributes associated with a plurality of content verticals of the content data. The computer-implemented method can comprise determining, by the computing system, based on inputting the one or more attributes associated with the content data into the one or more machine-learned models, one or more evaluated attributes comprising the one or more attributes that satisfy one or more evaluation criteria associated with a validity of the one or more attributes. The computer-implemented method can comprise generating, by the computing system, attribute data based on the one or more evaluated attributes.

Another example aspect of the present disclosure is directed to one or more tangible non-transitory computer-readable media storing computer-readable instructions that when executed by one or more processors cause the one or more processors to perform operations. The operations can comprise receiving schema data comprising web content and a plurality of queries. The operations can comprise determining, based on inputting the schema data into one or more machine-learned models, a plurality of schemas comprising one or more attributes of geographic locations associated with the schema data. The one or more machine-learned models can be configured to determine the plurality of schemas based on recognition of one or more semantic features of the schema data. The operations can comprise retrieving, based on inputting the plurality of schemas into the one or more machine-learned models, content data comprising content from one or more content sources. The operations can comprise determining, based on inputting the content data and the plurality of schemas into the one or more machine-learned models, the one or more attributes associated with a plurality of content verticals of the content data. The operations can comprise determining, based on inputting the one or more attributes associated with the content data into the one or more machine-learned models, one or more evaluated attributes comprising the one or more attributes that satisfy one or more evaluation criteria associated with a validity of the one or more attributes. The operations can comprise generating attribute data based on the one or more evaluated attributes.

Another example aspect of the present disclosure is directed to a computing system comprising: one or more processors; one or more non-transitory computer-readable media storing instructions that when executed by the one or more processors cause the one or more processors to perform operations. The operations can comprise receiving schema data comprising web content and a plurality of queries. The operations can comprise determining, based on inputting the schema data into one or more machine-learned models, a plurality of schemas comprising one or more attributes of geographic locations associated with the schema data. The one or more machine-learned models can be configured to determine the plurality of schemas based on recognition of one or more semantic features of the schema data. The operations can comprise retrieving, based on inputting the plurality of schemas into the one or more machine-learned models, content data comprising content from one or more content sources. The operations can comprise determining, based on inputting the content data and the plurality of schemas into the one or more machine-learned models, the one or more attributes associated with a plurality of content verticals of the content data. The operations can comprise determining, based on inputting the one or more attributes associated with the content data into the one or more machine-learned models, one or more evaluated attributes comprising the one or more attributes that satisfy one or more evaluation criteria associated with a validity of the one or more attributes. The operations can comprise generating attribute data based on the one or more evaluated attributes.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

FIG. 1 depicts a block diagram of examples of operations performed by an attribute generation system according to example embodiments of the present disclosure;

FIG. 2 depicts an example of an interface that displays attributes that were generated based on a search according to example embodiments of the present disclosure;

FIG. 3 depicts an example of a computing device according to example embodiments of the present disclosure;

FIG. 4 depicts a flow chart diagram of an example method of determining schemas and generating attribute data associated with geographic locations according to example embodiments of the present disclosure;

FIG. 5 depicts a flow chart diagram of an example method of determining schemas and generating attribute data associated with geographic locations according to example embodiments of the present disclosure; and

FIG. 6 depicts a flow chart diagram of an example method of determining schemas and generating attribute data associated with geographic locations according to example embodiments of the present disclosure;

FIG. 7 is a flow chart diagram illustrating an example method for training a machine-learned model according to example implementations of aspects of the present disclosure;

FIG. 8 is a block diagram of an example processing flow for using machine-learned model(s) to process input(s) to generate output(s) according to example implementations of aspects of the present disclosure;

FIG. 9 is a block diagram of an example sequence processing model according to example implementations of aspects of the present disclosure;

FIG. 10 is a block diagram of an example technique for populating an example input sequence for processing by a sequence processing model according to example implementations of aspects of the present disclosure;

FIG. 11 is a block diagram of an example model development platform according to example implementations of aspects of the present disclosure;

FIG. 12 is a block diagram of an example training workflow for training a machine-learned model according to example implementations of aspects of the present disclosure;

FIG. 13 is a block diagram of an inference system for operating one or more machine-learned model(s) to perform inference according to example implementations of aspects of the present disclosure;

FIG. 14 is a block diagram of an example networked computing system according to example implementations of aspects of the present disclosure;

FIG. 15 is a block diagram of an example computing device according to example implementations of aspects of the present disclosure; and

FIG. 16 is a block diagram of an example computing device according to example implementations of aspects of the present disclosure.

### DETAILED DESCRIPTION

In general, the present disclosure is directed to generating attribute data that indicates the attributes of classes of establishments and/or locations. Generation of the attribute data can be based on the generation of schemas that can be used to extract content (e.g., web content) from sources including web pages. Machine-learned models (e.g., large language models) can then be used to determine attributes associated with content verticals based on the detection, recognition, and/or classification of features in the extracted content. The attribute data that is generated can be associated with classes of establishments and/or locations (e.g., hotels, restaurants, and/or parks).

Further, the disclosed technology can automatically generate attribute data that can comprise specific attributes that are associated with specific classes of establishments and/or locations. In particular, in addition to generating attribute data associated with frequently searched attributes such as the name or telephone number of a business, the disclosed technology can generate long-tail attribute data that comprises more narrowly focused information such as whether an establishment has certain types of amenities (e.g., whether a hotel offers spa service) and/or allows certain types of activities (e.g., whether a restaurant allows dogs to accompany diners).

The disclosed technology can include a computing system that receives schema data that can comprise web content and a plurality of queries. For example, the schema data can comprise web pages and/or search query logs based on the search queries of users. Further, the computing system can determine, based on inputting the schema data into one or more machine-learned models, a plurality of schemas associated with the schema data. The one or more machine-learned models can be configured to determine the plurality of schemas based on the detection, recognition, and/or classification of one or more semantic features of the schema data. For example, the machine-learned models can be configured and/or trained to identify relevant portions of search queries to determine the plurality of schemas comprising long-tail classes associated with establishments that were searched for in the search queries.

The computing system can then retrieve, based on inputting the plurality of schemas into the one or more machine-learned models, content data comprising content from one or more content sources. For example, the computing system can retrieve content comprising the text and imagery of web pages as well as user generated content from other sources such as applications (e.g., social media applications). The computing system can then determine, based on inputting the content data and the plurality of schemas into the one or more machine-learned models, one or more attributes associated with a plurality of content verticals of the content data. For example, the computing system can determine more general attributes such as the name and address of an establishment as well as more specific attributes that indicate whether an establishment provides a concierge.

Based on inputting the one or more attributes associated with the content data into the one or more machine-learned models, the computing system can determine one or more evaluated attributes that comprise the one or more attributes that satisfy one or more evaluation criteria associated with the validity of the one or more attributes. For example, the computing system can determine that attributes that occur outside a predetermined frequency range (e.g., attributes that occur at less than a frequency threshold) may not satisfy the evaluation criteria. Furthermore, the computing system can generate attribute data based on the one or more evaluated attributes. For example, the plurality of attributes can comprise evaluated attributes comprising broadly relevant attributes such as the name and/or telephone number of a business as well as more narrowly focused attributes such as whether children are permitted to use certain facilities at a recreational area.

Accordingly, the disclosed technology can generate improved attribute data that can be used to improve search results by providing attribute data that includes attributes that target long-tail information more specifically. Further, the disclosed technology can assist a user in more effectively and/or safely performing the technical task of information search, retrieval, and processing by means of a continued and/or guided human-machine interaction process in which content from websites and other sources is received and the disclosed technology generates attribute data based on continuously updated content. For example, a user can use a smartphone to generate a search query to search for restaurants that allow diners to bring pets. The search query can be sent to a remote machine-learned model system that determines restaurants associated with attributes indicating that the restaurants allow pets. The attributes can then be sent back to the user's smartphone.

The disclosed technology can be implemented in a computing system (e.g., an attribute generation computing system) that is configured to access data and/or perform operations on the data. For example, the operations performed by the computing system can comprise receiving schema data, determining a plurality of schemas based on inputting the schema data into machine-learned models, retrieving content data, determining attributes based on inputting the content into the machine-learned models, determining evaluated attributes comprising the attributes that satisfy evaluation criteria, and generating attribute data based on the evaluated attributes. Further, the computing system can leverage one or more machine-learned models that have been configured and/or trained to process (e.g., detect, recognize, and/or classify) input comprising schema data and/or content data and generate attribute data based on processing the input.

The computing system can be included as part of a system that includes a server computing device that receives data (e.g., schema data, content data, and/or attribute data) from a user's client computing device, performs operations based on the data and sends output comprising attribute data back to the client computing device. In some embodiments, the computing system can include specialized hardware and/or software that enables the performance of operations specific to the disclosed technology. For example, the computing system can include one or more application specific integrated circuits and/or neural processing units that are configured to perform operations associated with receiving schema data, determining a plurality of schemas based on inputting the schema data into machine-learned models, retrieving content data, determining attributes based on inputting the content into the machine-learned models, determining evaluated attributes comprising the attributes that satisfy evaluation criteria, and generating attribute data based on the evaluated attributes.

The computing system can receive, access, and/or retrieve schema data. The schema data can comprise web content and/or a plurality of queries. Further, the schema data can comprise one or more text segments (e.g., articles from web pages, user reviews from web pages, and/or text-based search queries), one or more images (e.g., images of hotels, restaurants, and/or campgrounds), one or more audio segments (e.g., audio based advertisements associated with a geographic location), and/or one or more video segments (e.g., video based reviews of a restaurant). Further, the schema data can comprise one or more text segments extracted from a document and/or an application (e.g., a social media application). In some embodiments, the schema data can comprise information (e.g., metadata) that can be used to determine the structure of the schema data and/or additional information that is not visible in a web page (e.g., the source code of a web page). For example, the schema data can comprise image metadata that can indicate the location (e.g., longitude, latitude, and/or altitude) associated with a geographic location.

In some embodiments, the schema data and/or the content data can comprise user generated content and/or a plurality of web pages. Further, the user generated content can comprise one or more images, one or more text segments, one or more audio segments, and/or one or more video segments. For example, the user generated content can comprise text-based social media messages, video reviews of an amusement park, audio based reviews of hotels, and/or images of scenic locations generated by users. Further, the plurality of web pages can comprise a plurality of aggregator web site pages and/or a plurality of authority web site pages. The schema data can comprise one or more portions of the content data. Further, the content data can comprise one or more portions of the schema data.

In some embodiments, the user generated content can comprise a plurality of user reviews. For example, the plurality of user reviews can comprise text-based reviews of geographic locations and/or the amenities available at the locations. Further, the user generated content can comprise information associated with a location at which the user generated content was generated.

The computing system can determine and/or generate a plurality of schemas. The plurality of schemas can be associated with the schema data. In some embodiments, the plurality of schemas can comprise structured data that can comprise one or more attributes of geographic locations that can be associated with the schema data. The plurality of schemas can be determined based on inputting the schema data into one or more machine-learned models. The one or more machine-learned models can be configured and/or trained to determine the plurality of schemas based on detection, recognition, and/or classification of one or more semantic features of the schema data. For example, based on inputting schema data comprising web pages associated with hotel reviews into one or more machine-learned models (e.g., one or more large language models (LLMs)), the one or more machine-learned models can generate output comprising schemas that comprise classes of attributes associated with amenities of the hotels and niche features requested by previous guests of the hotels indicated in the hotel reviews. In some embodiments, the one or more machine-learned models can comprise one or more large language models that can be configured and/or trained to generate the one or more attributes based on input comprising one or more prompts associated with the schema data. For example, based on inputting one or more prompts associated with schema data comprising hotel reviews, the one or more machine-learning models comprising one or more large language models can generate output comprising a plurality of schemas based on the schema data.

In some embodiments, the computing system can generate a plurality of schema clusters (e.g., a plurality of clusters of the schema data based on the similarity of one or more portions of the schema data to one or more other portions of the schema data). For example, based on schema data comprising search queries comprising hotels, motels, bed and breakfasts, inns, and/or hostels, the one or more machine-learned models can generate a schema cluster comprising schema data that is associated with the broad category of lodgings and includes hotels, motels, bed and breakfasts, inns, and/or hostels. By way of further examples, based on schema data comprising search queries comprising dogs permitted, cats welcome, and/or pets allowed, the one or more machine-learned models can generate a schema cluster comprising search queries that are associated with the broad category of pet friendliness and includes dogs permitted, cats welcome, and/or pets allowed.

The computing system can receive, access, and/or retrieve content data. The content data can comprise content from one or more content sources. The content data can be retrieved based on inputting the plurality of schemas into the one or more machine-learned models. Further, the one or more machine-learned models can be configured and/or trained to process the plurality of schemas and search web pages and other content sources (e.g., user generated content stored in databases) for content that is associated with the plurality of schemas. For example, based on schemas associated with the attributes of hotels, the one or more machine-learned models can search for content associated with hotels, access web pages associated with hotels, and retrieve content data (e.g., text-based content, images, and/or video associated with hotels) from the web pages associated with the hotels.

The computing system can determine and/or generate one or more attributes. The one or more attributes can be associated with a plurality of content verticals of the content data. Determining and/or generating the one or more attributes can be based on inputting the content data, the plurality of schemas, and/or the plurality of schema clusters into the one or more machine-learned models. The one or more machine-learned models can be configured and/or trained to receive input comprising content data, the plurality of schemas, and/or the plurality of schema clusters. The one or more machine-learned models can then perform a plurality of operations to process the content data (e.g., detect and/or recognize content associated with content verticals associated with geographic locations, then classify the detected and recognized content into one or more attributes associated with content verticals), the plurality of schemas, and/or the plurality of schema clusters, and generate output comprising the one or more attributes.

For example, based on input comprising content data associated with web pages that comprise information associated with amusement parks, the one or more machine-learned models can generate output comprising content verticals associated with amusement parks and one or more attributes comprising the amenities (e.g., attractions and/or places to eat) at the amusement parks. In some embodiments, the one or more machine-learned models can comprise one or more large language models that can be configured and/or trained to generate the one or more attributes based on input comprising one or more prompts associated with the content data and/or plurality of schemas. For example, based on inputting one or more prompts associated with content data comprising web pages associated with amusement parks and/or a plurality of schemas associated with amusement parks into one or more machine-learned models comprising one or more large language models (LLMs), the one or more machine-learned models can generate output comprising one or more attributes associated with the rides, amenities, features, and/or attractions of the amusement parks included in the content data.

In some embodiments, the computing system can be configured to deduplicate the plurality of content verticals and/or the one or more attributes that are similar. For example, if some content verticals and/or attributes are very similar (e.g., content verticals that are synonymous with one another such as “restaurant” and “eatery”), the computing system can deduplicate the similar content verticals and/or attributes. Further, the computing system can determine and/or generate a plurality of clustered content verticals based on the plurality of content verticals that are similar. Further, the computing system can determine and/or generate one or more clustered attributes based on the one or more attributes that are similar. For example, based on input comprising content verticals comprising hotels, motels, bed and breakfasts, inns, and/or hostels, the one or more machine-learned models can generate a cluster of content verticals that is associated with the broad category of lodgings and includes hotels, motels, bed and breakfasts, inns, and/or hostels. By way of further examples, based on input comprising attributes comprising dogs permitted, cats welcome, and/or pets allowed, the one or more machine-learned models can generate a cluster of attributes that is associated with a broad category of pet friendliness and includes dogs permitted, cats welcome, and/or pets allowed.

Further, the computing system can determine that the plurality of content verticals and/or the one or more attributes are deduplicated and/or clustered to result in a predetermined distribution of the plurality of content verticals and/or attributes. For example, if content verticals associated with dental clinics are overrepresented (e.g., the number of specific content verticals exceeds some threshold portion of the total number of content verticals) then the content verticals associated with dental clinics can be reduced until the content verticals associated with dental clinics are not overrepresented. By way of further example, if attributes associated with urgent care centers are overrepresented (e.g., the number of specific attributes exceeds some threshold portion of the total number of attributes) then the attributes associated with urgent care centers can be reduced until the attributes associated with urgent care centers are not overrepresented.

The computing system can determine and/or generate one or more evaluated attributes. The one or more evaluated attributes can comprise the one or more attributes that satisfy one or more evaluation criteria. The one or more attributes can comprise the one or more attributes that have been deduplicated, the one or more attributes that have been clustered (e.g., one or more clustered attributes), the plurality of content verticals, and/or the plurality of content verticals that have been clustered (e.g., the plurality of clustered content verticals). The one or more evaluation criteria can be associated with the validity of the one or more attributes. Determining and/or generating the one or more evaluated attributes can be based on inputting the one or more attributes associated with the content data into the one or more machine-learned models. The one or more machine-learned models can be configured and/or trained to receive input comprising the one or more attributes and perform a plurality of operations to determine the one or more attributes that satisfy the one or more evaluation criteria and generate output comprising the one or more evaluated attributes. For example, based on input comprising one or more attributes associated with campground amenities, the one or more machine-learned models can generate output comprising one or more evaluated attributes that are relevant to campgrounds (e.g., times of year the campgrounds are open to the public) and not including attributes that are not relevant to campgrounds (e.g., the social media contact information associated with the friends of a park ranger who manages the campgrounds).

The one or more evaluation criteria can comprise one or more relevance criteria associated with a relevance of the one or more attributes with respect to the plurality of content verticals. The one or more relevance criteria may be used to determine the extent to which an attribute is relevant to a content vertical. Further, a relevance score that is positively correlated with the relevance of an attribute with respect to a content vertical can be generated and an attribute with a relevance score that exceeds a relevance threshold can be determined to satisfy the one or more evaluation criteria. For example, an attribute that is associated with the times at which starting a campfire is permitted may be a relevant attribute for a campground (e.g., an attribute that satisfies the one or more evaluation criteria) and not a relevant attribute for a restaurant (e.g., an attribute that does not satisfy the one or more evaluation criteria).

The computing system can generate attribute data. The attribute data can be based on the one or more evaluated attributes. Further, the attribute data can comprise one or more portions of the one or more schemas. For example, the attribute data can comprise classes of attributes (e.g., hotels, restaurants, campsites, and/or parks) that can be associated with various geographic locations and/or the attributes associated with the geographic locations. Further, the attribute data can be arranged so that search of the attribute data is facilitated. For example, a plurality of attribute embeddings can be generated based on the one or more evaluated attributes.

The one or more machine-learned models can comprise one or more prompt generation models that are configured to generate one or more prompts to determine whether an attribute of the one or more attributes is associated with one or more portions of the content. Further, the one or more attributes can be generated based on inputting the one or more prompts into the one or more machine-learned models. For example, based on content data comprising content associated with the amenities at an amusement park, the one or more prompt generation models can generate prompts that can determine whether certain amenities are available and/or whether there are specific restrictions (e.g., age restrictions or height restrictions) associated with amenities at a geographic location.

In some embodiments, the one or more prompt generation models can be configured and/or trained to generate one or more prompts that can be used to generate one or more clusters that comprise one or more attributes and/or the plurality of content verticals that are similar (e.g., semantically related attributes and/or semantically related content verticals). Further, the one or more machine-learned models can comprise one or more large language models and the one or more prompt generation models can be configured and/or trained to generate prompts that can be inputted into the one or more large language models in order to generate output comprising one or more clusters comprising one or more attributes that are clustered and/or a plurality of content verticals that are clustered. For example, the one or more prompt generation models can generate the prompt “CLUSTER SEMANTICALLY RELATED ATTRIBUTES THAT ARE ASSOCIATED WITH SPAS IN CHICAGO.” The prompt and/or a plurality of attributes (e.g., attributes associated with spas) could then be inputted into a large language model, which could then generate clusters of attributes associated with spas (e.g., spas, hot springs, mineral springs, and/or mud baths).

The one or more prompt generation models can be configured and/or trained based on training data. The training data can comprise a plurality of ground-truth prompts (e.g., ground-truth prompts that can be used to search data (e.g., training content data) and return Boolean type (e.g., true or false) search results), training schema data (e.g., training schema data that can comprise user generated content (e.g., user reviews) and/or other web content), training content data that can be searched based on prompts that can comprise predicted prompts generated by the one or more prompt generation models and/or the plurality of ground-truth prompts), and/or a plurality of ground-truth search results. The one or more prompt generation models can be trained over a plurality of iterations in which predicted prompts are generated by the one or more prompt generation models based on input comprising the schema data.

Search results can be generated based on using the predicted prompts to search the training content data. The search results based on the predicted prompts can be compared to search results generated based on the plurality of ground-truth prompts. A loss associated with the accuracy of the search results associated with the predicted prompts (e.g., the similarity of the predicted prompts to the ground truth prompts) can be determined. The loss can be based on one or more differences between the plurality of predicted prompts and the plurality of ground-truth prompts can be generated. Further, the loss can be positively correlated with the difference between a predicted prompt and a ground-truth prompt that is used to generate a search result. Further, parameters of the one or more prompt generation models can be adjusted in order to minimize the loss. The weights of parameters associated with increasing the loss can be decreased and/or the weights of parameters associated with decreasing the loss can be increased. The one or more prompt generation models can be trained until a threshold level of accuracy (e.g., 98% accuracy) is achieved.

The one or more prompts can be configured to elicit a Boolean type of response that indicates whether the attribute indicated in each prompt is associated with one or more portions of content indicated in the prompt. For example, the prompt “CAN CHILDREN UNDER THE AGE OF 14 SWIM IN THE POOL UNACCOMPANIED?” can elicit a Boolean response in which the response to the prompt is either yes or no. Further, the prompt “DOGS ARE ALLOWED IN THE RESTAURANT?” can elicit a Boolean response in which the response to the prompt is true or false.

In some embodiments, the one or more content sources can comprise a plurality of web pages. Further, the one or more machine-learned models can be configured and/or trained to scrape the content data from the one or more content sources comprising the plurality of web pages. For example, the one or more machine-learned models can be configured and/or trained to access the Internet and scrape content data associated with the plurality of schemas (e.g., schemas associated with geographic locations and/or establishments) from a plurality of web pages.

In some embodiments, the plurality of content verticals can be associated with a plurality of classes of establishments and/or a plurality of classes of locations. For example, the plurality of content verticals can be associated with a plurality of classes of establishments comprising broad classes of short-term accommodations (e.g., hotels, motels, and/or hostels) or more narrowly focused classes of a specific type of short-term accommodation such as hotels (e.g., luxury hotels, budget hotels, and/or hotel resorts). Further, the plurality of content verticals can be associated with a plurality of classes of locations which can include outdoor locations (e.g., beaches and/or parks) and/or indoor locations (e.g., restaurants, hotels, and/or amusement parks).

In some embodiments, the plurality of content verticals and/or the plurality of classes of establishments can comprise hotels, restaurants, stores, shopping centers, fitness centers, houses of worship, gas stations, charging stations, amusement parks, museums, art galleries, beaches, breweries, car washes, food banks, aquariums, spas, zoos, grocery stores, nail salons, golf courses, campgrounds, and/or medical centers (e.g., hospitals, dentist offices, urgent care centers, and/or medical clinics). Further, the plurality of classes of locations can comprise beaches, parks, trails, indoor locations, outdoor locations, recreational areas, urban locations, and/or suburban locations.

In some embodiments, the plurality of schemas can correspond to the plurality of content verticals. For example, a schema for hotels can correspond to a content vertical for hotels. By way of further example, a schema for campgrounds can correspond to a content vertical for campgrounds.

In some embodiments, the computing system can determine and/or generate a plurality of content vertical clusters and/or one or more attribute clusters. The plurality of content vertical clusters can be based on a plurality of queries associated with each content vertical of the plurality of content verticals. Further, the plurality of content vertical clusters and/or the one or more attribute clusters can be arranged and/or organized hierarchically. For example, the computing system can generate a dental content vertical cluster based on queries associated with oral surgery clinics, tooth whitening centers, and/or orthodontics clinics. By way of further example, the computing system can generate an activity attribute cluster based on attribute queries associated with equestrian attributes, birdwatching attributes, and/or wind surfing attributes.

The computing system can determine and/or generate a ranking of the plurality of content verticals and/or the plurality of content vertical clusters. For example, the computing system can generate a ranking (e.g., a ranking in which the plurality of content verticals are prioritized based on relevance and/or frequency) of the plurality of content verticals. The ranking of the plurality of content verticals can be based on a frequency of the plurality of queries associated with each content vertical of the plurality of content verticals. The frequency of the plurality of content verticals can be based in part on determining the number of queries associated with each content vertical of the plurality of content verticals. Further, the ranking of the plurality of content verticals based on a frequency of the plurality of queries associated with each content vertical cluster of the plurality of content vertical clusters.

Further, the computing system can determine and/or generate a ranking of the plurality of content vertical clusters and/or the one or more attribute clusters. In some embodiments, the one or more machine-learned models can be configured to determine and/or generate the plurality of content vertical clusters and/or the one or more attribute clusters. The one or more machine-learned models can comprise one or more clustering models that are configured and/or trained to generate the plurality of content vertical clusters based on input comprising the plurality of clusters. Further, the one or more machine-learned models can comprise one or more clustering models that are configured and/or trained to generate one or more attribute clusters based on input comprising the one or more attributes. For example, the one or more machine-learned models can receive input comprising different types of content vertical locations (e.g., ponds, lakes, beaches, swimming pools, and/or water parks) and generate an aquatic content vertical cluster that includes the various types of aquatic related locations.

The computing system can determine that the one or more attributes are associated with the plurality of content verticals and/or the plurality of content vertical clusters that are associated with the plurality of queries that occur at less than a threshold frequency. For example, based on a threshold frequency of the bottom ten percent of content verticals, the computing system can determine that the one or more attributes are associated with the plurality of content verticals that are in the bottom ten percent of the frequency distribution.

The computing system can generate and/or determine a plurality of attribute embeddings. The plurality of attribute embeddings can be associated with the attribute data. Generating and/or determining the plurality of attribute embeddings can be based on inputting the attribute data into the one or more machine-learned models. The plurality of attribute embeddings can be generated based on processing features (e.g., detecting, recognizing, and/or classifying semantic features of one or more portions of the attribute data) of the attribute data and generating a plurality of attribute embeddings that comprise a feature spaces (a plurality of feature vectors) that represent features of the one or more portions of the attribute data and have a lower dimensionality than the attribute data query on which the plurality of attribute embeddings are based.

The computing system can receive a search query. For example, the computing system can receive a search query that is associated with a search application and/or a navigation application. For example, a search query associated with a search for places to eat in a particular city can indicate “WHAT ARE THE BEST PLACES TO EAT IN CHICAGO?”). Further, the search query can be inputted into an application that is being executed on the computing system (e.g., a search application and/or a navigation application). The search query can comprise a text-based search query (e.g., a query comprising text that is provided via an input device which can include an onscreen keyboard). In some embodiments, a search query can be based on input from an audio input device comprising a microphone. For example, a computing system can be configured to recognize and/or parse speech that is detected by a microphone of the computing system.

The computing system can generate a search query embedding based on the search query. The search query embedding can be generated, based on inputting the search query into one or more machine-learned models that are configured and/or trained to generate the search query embedding based on input comprising the search query. The search query embedding can be generated based on processing features (e.g., detecting, recognizing, and/or classifying semantic features of the search query) of the search query and generating an embedding that comprises a feature space (a plurality of feature vectors) that represent features of the search query and has a lower dimensionality than the search query on which the search query embedding is based.

The computing system can generate and/or determine search output. The search output can be based on one or more portions of the attribute data associated with the search query. Generating and/or determining the search output can be based on comparing the search query embedding to the plurality of attribute embeddings. For example, the search query embedding can be compared to a plurality of attribute embeddings. Based on the comparison of the search query embedding to the plurality of attribute embeddings, the associated attribute embeddings that are relevant to the search query associated with the search query embedding can be determined. For example, based on a search for hiking trails, the computing system can generate search output comprising hiking trails and attributes of hiking trails including hiking trails with scenic views or hiking trails that follow a body of water such as a lake or river.

Further, the computing system can generate the output via an interface (e.g., a graphical user interface) that can be outputted via an output device (e.g., a display component). for example, the computing system can generate an interface that includes the search query and/or the attribute data associated with the search query. For example, in response to a search query associated with pet friendly spas (e.g., spas that permit guests to bring their dogs), the computing system can generate a listing of pet friendly spas that includes attributes of the spas (e.g., attributes including an attribute that indicates whether a pet is permitted in the spa) and/or images of the spas. In some embodiments, the computing system can generate audio (e.g., a synthetic voice that announces the names of the spas that are pet friendly) via an audio output component of the computing system.

The one or more machine-learned models can comprise one or more large language models (LLMs). Further, the one or more LLMs can be configured and/or trained to generate output comprising attribute data based on input comprising schema data, one or more attributes, and/or content data.

Further, the one or more machine-learned models can be configured and/or trained to determine schemas and/or attributes. The computing system can receive training data. The training data can comprise a plurality of training schema data, training content data, training attribute data, training attributes, training schemas, training evaluated attributes, ground-truth schemas, ground-truth attributes, and/or ground-truth evaluated attributes.

In some embodiments, the training data can comprise a plurality of embeddings. The plurality of embeddings can comprise a lower-dimensionality vector space representation of the training data. For example, the schema data and/or content data can be represented in a lower-dimensional vector space that can preserve information about the features of text or images in a smaller dimensional vector space than the higher-dimensional vector space of the original content data (e.g., a high-dimensional vector space that can include the full text of a user review or the full resolution version of an image). The plurality of embeddings can be arranged such that semantically similar code segments are closer together in the vector space.

Further, training the one or more machine-learned models can comprise generating and/or determining, based on inputting the training data into the one or more machine-learned models, a plurality of predicted attributes. Based on the received input, the one or more machine-learned models can perform one or more operations and generate an output comprising a plurality of predicted attributes associated with a plurality of schemas and/or content data. The output of the one or more machine-learned models can then be evaluated based on one or more comparisons of the plurality of predicted attributes to a corresponding plurality of ground-truth attributes with the training data (e.g., ground-truth attributes based on the same schemas and content data as the corresponding predicted attributes).

Training the one or more machine-learned models can comprise determining a loss based on one or more differences between the plurality of predicted attributes and the plurality of ground-truth attributes. A loss function can be used to determine the loss. Further, the loss function can be used to evaluate one or more differences between the plurality of predicted attributes and the plurality of ground-truth attributes. The loss can increase in proportion to the number of the one or more differences between the plurality of predicted attributes and the plurality of ground-truth attributes. For example, if a predicted attribute and the corresponding ground-truth attribute are very dissimilar (e.g., the predicted attribute indicates whether a hotel has a pool and the ground-truth attribute indicates whether a restaurant permits dogs), the loss can be greater than if the predicted is very similar to the corresponding ground-truth attribute (e.g., the predicted attribute indicates whether a restaurant permits pets and the ground-truth attribute indicates whether a restaurant permits dogs).

Training the one or more machine-learned models can comprise modifying a plurality of parameters of the one or more machine-learned models to minimize the loss. The plurality of parameters can be associated with detection, recognition, and/or classification of one or more features of the training data that can be used to determine the plurality of predicted attributes. Further, the plurality of parameters can be associated with a plurality of weights that can be associated with an extent to which the plurality of parameters contribute to determining the loss.

Training the one or more machine-learned models can be performed over a plurality of iterations. In each iteration of training, the weight of the plurality of parameters that contribute to increasing the loss can be reduced and/or the weight of the plurality of parameters that contribute to decreasing the loss can be increased. As a result, the plurality of weights of the plurality of parameters can be associated with the plurality of predicted attributes such that parameters that are more heavily weighted can contribute more to determining the predicted attributes than parameters that are less heavily weighted. Over the plurality of iterations, the weights of the plurality of parameters can be modified to minimize the loss until a threshold loss that corresponds to a high accuracy of the one or more machine-learned models determining the plurality of predicted attributes is achieved. For example, the loss can be minimized until a threshold loss associated with 99% accuracy is achieved by the machine-learned model.

The systems, methods, devices, and/or computer-readable media (e.g., tangible non-transitory computer-readable media) in the disclosed technology can provide a variety of technical effects and benefits including an improvement in the effectiveness with which attributes associated with content data from sources comprising web pages and user generated content is generated based on the implementation of machine-learned models (e.g., LLMs) that perform operations to detect, recognize, and/or classify features (e.g., low-level visual features of images in content data and/or semantic features of text-based content) of the content data. Further, improved generation of attributes based on the generation of schemas and detection, recognition, and/or classification of features of content data can assist a user by providing more relevant and/or accurate attributes that can be used for tasks including navigation. The disclosed technology can also improve the effectiveness with which computational resources are used by leveraging one or more machine-learned models that are able to determine features (e.g., attributes of web pages associated with search results) more efficiently.

Further, the disclosed technology can improve the effectiveness with which attributes based on content is generated based on processing content data that is searched for, retrieved, and/or distributed from a variety of data sources. The large volume of content that is available on the Internet can present the challenging task of generating search results that include relevant attributes. In many cases, the attributes returned in search results may be overly broad and do not address the requirements of a search. The ability to generate relevant attributes that cover broad information (e.g., the hours of operation of an establishment) as well as more focused information (e.g., whether a petting zoo has llamas) can improve the quality of search results.

Additionally, the disclosed technology can leverage large language models to determine more narrowly tailored attributes more efficiently. By using large language models and generating prompts that are custom tailored to determine specific types of attributes, the disclosed technology may more efficiently generate attributes relative to more bespoke approaches.

As such, the disclosed technology can allow the user of a computing system to perform the technical task of generating attributes for geographic locations based on the detection, recognition, and/or classification of features of content data (e.g., web content and/or user generated content). As a result, users can be provided with the specific benefits of improved performance (classification performance and/or attribute generation performance) and more efficient use of system resources. Further, any of the specific benefits provided to users can be used to improve the effectiveness of a wide variety of devices and services including devices that perform search operations and/or use attributes returned in search results. Accordingly, the improvements offered by the disclosed technology can result in tangible benefits to a variety of devices and/or systems including mechanical, electronic, and computing systems associated with generating and/or processing attributes.

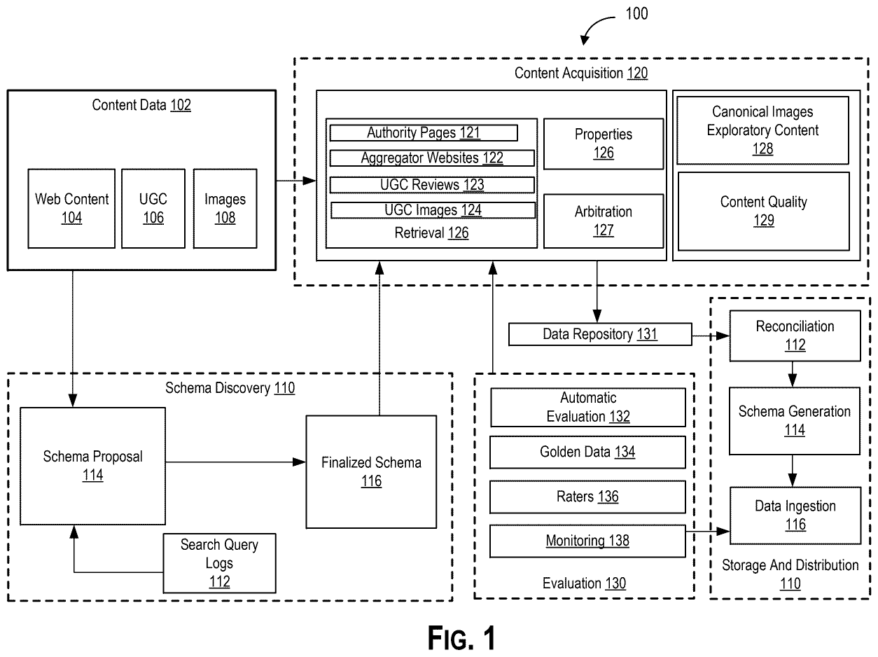

With reference now to the figures, example embodiments of the present disclosure will be discussed in further detail. FIG. 1 depicts a block diagram of examples of operations performed by an attribute generation system according to example embodiments of the present disclosure. One or more operations described with respect to a system 100 can be executed and/or implemented on one or more computing devices or computing systems comprising, for example, the computing device 50, the server computing system 60, the model development platform system 70, and/or the computing device 300. Further, one or more portions of the operations described with respect to the system 100 can be executed or implemented as an algorithm on the hardware devices or systems disclosed herein.

In some implementations, a schema discover computing system 110 can access search query logs 112 (e.g., one or more search queries that can comprise searches for geographic locations and/or establishments). Based on the search query logs 112 and/or data (e.g., schema data and/or content data comprising web content 104, user generated content 106, and/or images 108) from the content data computing system 102, a schema proposal 114 associated with a schema can be generated based on inputting the search query logs 112 into one or more machine-learned models (e.g., one or more LLMs). Over a plurality of iterations, the one or more machine-learned models (e.g., one or more LLMs configured and/or trained to process (e.g., parse) the search query logs 112 and/or determine a plurality of schemas based on input comprising the search query logs 112) can generate the finalized schema 116. The finalized schema 116 can be sent to the content acquisition computing system 120.

The content acquisition computing system 120 can perform operations based on the finalized schema 116 and/or the content data received from the content data computing system 102 (e.g., content data comprising web content 104, user generated content 106, and/or images 108). In some embodiments, the content acquisition computing system 120 can perform retrieval operations 126 to retrieve and/or extract authority pages 121, aggregator websites 122, user generated content reviews 123, and/or user generated content images 124 from the content data received from the content data computing system 102.

Further, the content acquisition computing system 120 can determine attributes and/or properties of the content data based on implementing one or more machine-learned models (LLMs) that are configured and/or trained to determine attributes of geographic locations and/or establishments from the content data. The content acquisition computing system 120 can then perform arbitration operations 127 to determine which attributes to send to data repository 131. Additionally, the content acquisition computing system 120 can acquire canonical images and exploratory content 128. The canonical images can comprise relevant images that can be used to accompany attributes. Further, the exploratory content can comprise opinions and user summaries.

Quality evaluation computing system 130 can implement one or more machine-learned models (LLMs) that have been configured and/or trained to perform automatic evaluation operations 132 that comprise evaluating the validity and/or relevance of attributes generated by the content acquisition computing system 120. The one or more machine-learned models of the quality evaluation computing system 130 can be configured and/or trained based on golden data 134 (e.g., labelled training data that comprises content attribute pairs) and/or raters 138 which can include automated raters (e.g., machine-learned models trained to evaluate attributes and/or generate evaluated attributes). Further, the quality evaluation computing system 130 can perform operations to monitor data comprising attributes that are received by the storage and distribution computing system 140 when data ingestion operations 146 are performed. Further, the storage and distribution computing system 140 can perform reconciliation operations 142 based on the attributes received from the data repository 131. Further, the storage and distribution computing system 140 can perform the schema generation operations 144 to generate schemas. The schemas can then be processed by the data ingestion operations 146 which can also be used to provide attributes and/or schemas in search query results that are generated in response to search queries.

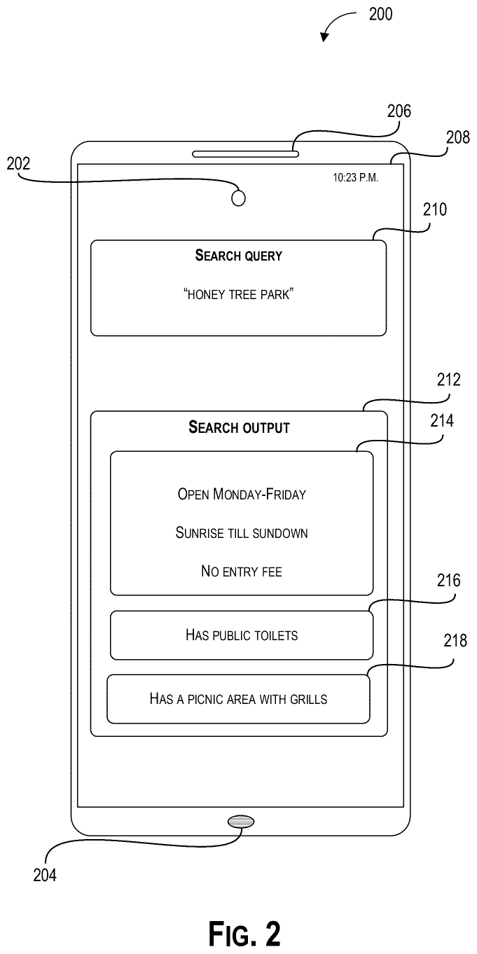

FIG. 2 depicts an example of an interface that displays attributes that were generated based on a search according to example embodiments of the present disclosure. A computing device 200 can include one or more features and/or capabilities of the computing device 50, the server computing system 60, the model development platform system 70, and/or the computing device 300.

The computing device 200 can include an imaging component 202, an audio input component 204, an audio output component 206, a display component 208, a search query 210, a search output 212, an attribute 214, an attribute 216, and an attribute 218.

The computing device 200 can be configured to perform one or more operations comprising sending, receiving, processing, and/or generating data associated with content data, schema data, and/or attribute data. Further, the computing device 200 can be configured to receive the search query 210 and generate the search output 212.

In this example, the computing device 200 has received the search query 210 via the display component 208, which is a touch sensitive display component. The search query 210 which indicates “HONEY TREE PARK” has been entered via an onscreen keyboard (not shown) that was generated by the computing device 200 and removed from view after the search output 212 was generated. In some embodiments, the search query 210 can be inputted into the computing device 200 via the audio input component 204 (e.g., a microphone) that can be used to detect speech that can be recognized by the computing device 200.

The computing device 200 can use the search query 210 as input one or more machine-learned models (LLMs) that can be implemented on the computing device 200 and/or that are implemented on a remote computing device that is able to send data to and/or receive data from the computing device 200. The one or more machine-learned models can be configured and/or trained to generate a search query embedding based on the search query 210, access a plurality of attribute embeddings, compare the search embedding to the plurality of attribute embeddings, and generate the search output 212.

In this example, the search output 212 comprises the attributes 214-218 that were generated based on the search query 210. In some embodiments, the search output 212 can comprise images, hyperlinks, video, and/or audio. The search output 212 can comprise attributes 214 which indicate that Honey Tree Park is “OPEN MONDAY-FRIDAY” from “SUNRISE TILL SUNDOWN” and that there is “NO ENTRY FEE” required to enter Honey Tree Park. Further, the attribute 216 can indicate that Honey Tree Park “HAS PUBLIC TOILETS.” Additionally, attribute 218 can indicate that Honey Tree Park “HAS A PICNIC AREA WITH GRILLS” which indicates an amenity that is available. In some embodiments, the search output 212 can comprise audio that can be outputted via the audio output component 206 (e.g., a loudspeaker). For example, the search output 212 can be outputted by a synthetic voice generated by the computing device 200.

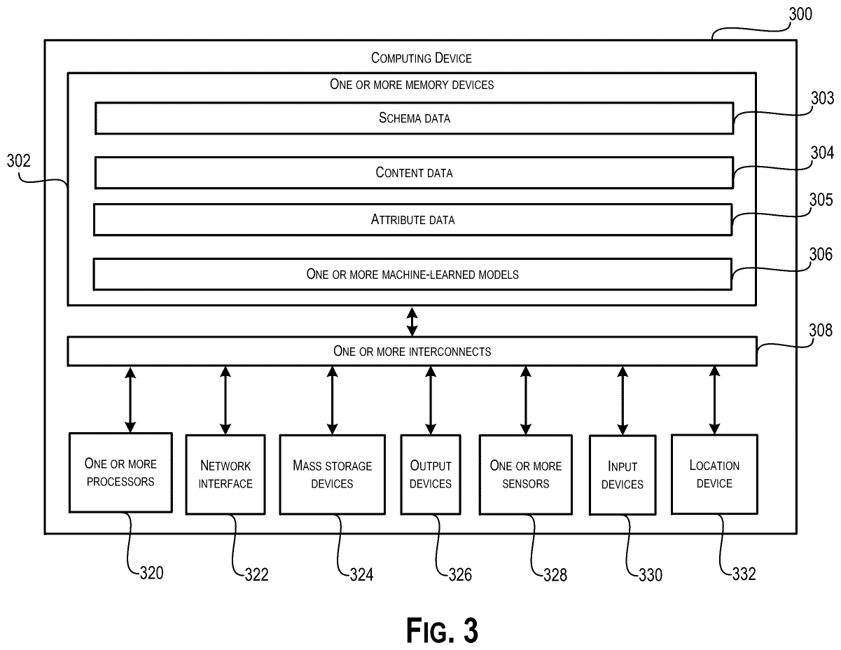

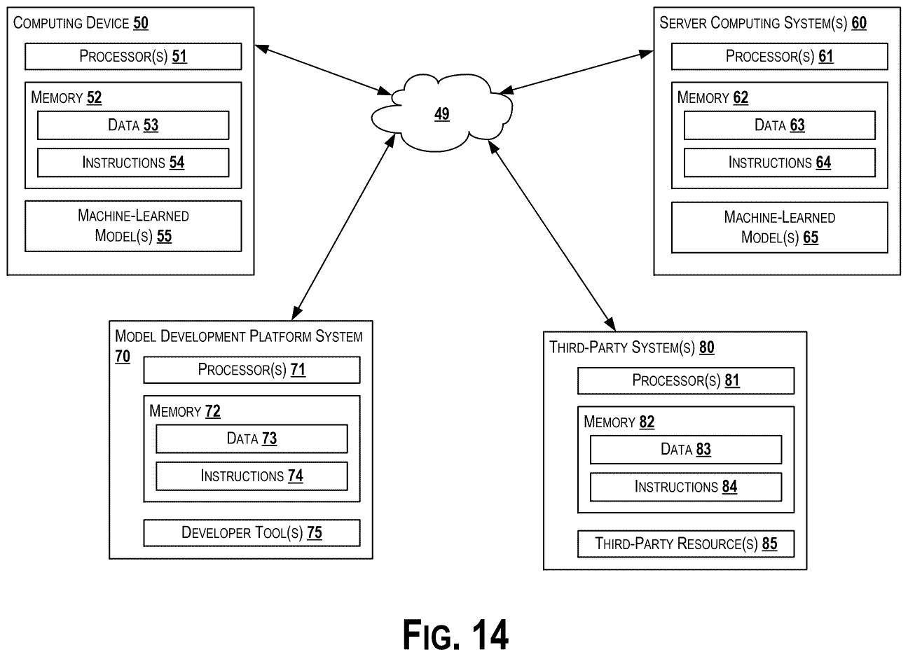

FIG. 3 depicts an example of a computing device according to example embodiments of the present disclosure. A computing device 300 can include one or more features and/or capabilities of the computing device 50, the server computing system 60, and/or the model development platform system 70. Furthermore, the computing device 300 can perform one or more actions and/or operations performed by the computing device 50, the server computing system 60, and/or the model development platform system 70, which are described with respect to FIG. 14.

As shown in FIG. 3, the computing device 300 can include one or more memory devices 302, schema data 303, content data 304, attribute data 305, one or more machine-learned models 306, one or more interconnects 308, one or more processors 320, a network interface 322, one or more mass storage devices 324, one or more output devices 326, one or more sensors 328, one or more input devices 330, and/or the location device 332. The computing device 300 can be configured as a desktop computing device and/or a mobile computing device (e.g., a smartphone, tablet computing device, and/or laptop computing device). Further, the computing device 300 can process and/or generate data (e.g., attribute data) based on data (e.g., content data) of the computing device 300 and/or data that is received from another computing device (e.g., content data that is generated by a remote computing device).

The one or more memory devices 302 can store information and/or data (e.g., the schema data 303, the content data 304, the attribute data 305, and/or the one or more machine-learned models 306). Further, the one or more memory devices 302 can include one or more computer-readable mediums (e.g., tangible non-transitory computer-readable media), including RAM, ROM, EEPROM, EPROM, flash memory devices, magnetic disks, and combinations thereof. The information and/or data stored by the one or more memory devices 302 can be executed by the one or more processors 320 to cause the computing device 300 to perform operations including receiving schema data, determining a plurality of schemas based on inputting the schema data into machine-learned models, retrieving content data, determining attributes based on inputting the content into the machine-learned models, determining evaluated attributes comprising the attributes that satisfy evaluation criteria, and generating attribute data based on the evaluated attributes.

The schema data 303 can include one or more portions of data (e.g., the data 53, the data 63, and/or the data 73, which are depicted in FIG. 14) and/or instructions (e.g., the instructions 54, the instructions 64, and/or the instructions 74 which are depicted in FIG. 14) that are stored in the memory 52, the memory 62, and/or the memory 72, respectively. The schema data 303 can comprise one or more search queries and/or user generated content from web pages. In some embodiments, the schema data 303 can be received from one or more computing systems (e.g., the server computing system 60 that is depicted in FIG. 14) which can include one or more computing systems that are remote from the computing device 300.

The content data 304 can include one or more portions of data (e.g., the data 53, the data 63, and/or the data 73, which are depicted in FIG. 14) and/or instructions (e.g., the instructions 54, the instructions 64, and/or the instructions 74 which are depicted in FIG. 14) that are stored in the memory 52, the memory 62, and/or the memory 72, respectively. In some embodiments, the content data 304 can be received from one or more computing systems (e.g., the server computing system 60 that is depicted in FIG. 14) which can include one or more computing systems that are remote from the computing device 300. The content data 304 can comprise content from web pages, image repositories, video streaming web sites, and/or audio streaming web sites.

The attribute data 305 can include one or more portions of data (e.g., the data 53, the data 63, and/or the data 73, which are depicted in FIG. 14) and/or instructions (e.g., the instructions 54, the instructions 64, and/or the instructions 74 which are depicted in FIG. 14) that are stored in the memory 52, the memory 62, and/or the memory 72, respectively. Furthermore, the attribute data 305 can include information associated with attributes of content that can comprise web pages and/or user generated content. In some embodiments, the attribute data 305 can be received from one or more computing systems (e.g., the server computing system 60 that is depicted in FIG. 14) which can include one or more computing systems that are remote from the computing device 300.

The one or more machine-learned models 306 (e.g., the one or more machine-learned models 55, the one or more machine-learned models 65, and/or the machine-learned models 75) can include one or more portions of the data 53, the data 63, and/or the data 73 which are depicted in FIG. 14 and/or instructions (e.g., the instructions 54, the instructions 64, and/or the instructions 74 which are depicted in FIG. 14) that are stored in the memory 52, the memory 62, and/or the memory 72, respectively. Furthermore, the one or more machine-learned models 306 can be configured and/or trained to perform operations comprising receiving schema data, determining a plurality of schemas based on inputting the schema data into machine-learned models, retrieving content data, determining attributes based on inputting the content into the machine-learned models, determining evaluated attributes comprising the attributes that satisfy evaluation criteria, and generating attribute data based on the evaluated attributes. In some embodiments, the one or more machine-learned models 306 can be received from one or more computing systems (e.g., the server computing system 60 that is depicted in FIG. 14) which can include one or more computing systems that are remote from the computing device 300.

The one or more interconnects 308 can include one or more interconnects or buses that can be used to send and/or receive one or more signals (e.g., electronic signals) and/or data (e.g., the schema data 303, the content data 304, the attribute data 305, and/or the one or more machine-learned models 306) between devices of the computing device 300, including the one or more memory devices 302, the one or more processors 320, the network interface 322, the one or more mass storage devices 324, the one or more output devices 326, the one or more sensors 328, and/or the one or more input devices 330. The one or more interconnects 308 can be arranged or configured in different ways, including as parallel or serial connections. Further the one or more interconnects 308 can include one or more internal buses to connect the internal components of the computing device 300; and one or more external buses used to connect the internal components of the computing device 300 to one or more external devices. By way of example, the one or more interconnects 308 can include different interfaces including Industry Standard Architecture (ISA), Extended ISA, Peripheral Components Interconnect (PCI), PCI Express, Serial AT Attachment (SATA), HyperTransport (HT), USB (Universal Serial Bus), Thunderbolt, IEEE 1394 interface (FireWire), and/or other interfaces that can be used to connect components.

The one or more processors 320 can include one or more computer processors that are configured to execute the one or more instructions stored in the one or more memory devices 302. For example, the one or more processors 320 can, for example, include one or more general purpose central processing units (CPUs), application specific integrated circuits (ASICs), neural processing units (NPUs), and/or one or more graphics processing units (GPUs). Further, the one or more processors 320 can perform one or more actions and/or operations including one or more actions and/or operations associated with the schema data 303, the content data 304, the attribute data 305, and/or the one or more machine-learned models 306. The one or more processors 320 can include single or multiple core devices including a microprocessor, microcontroller, integrated circuit, and/or a logic device.

The network interface 322 can support network communications. For example, the network interface 322 can support communication via networks including a local area network and/or a wide area network (e.g., the Internet). Further, the network interface 322 can be used to receive data (e.g., content data) from other computing devices. The one or more mass storage devices 324 (e.g., a hard disk drive and/or a solid-state drive) can be used to store data including the content data 304 and/or the one or more machine-learned models 306.

The one or more output devices 326 can include one or more display devices (e.g., LCD display, OLED display, Mini-LED display, microLED display, plasma display, and/or CRT display), one or more light sources (e.g., LEDs), one or more audio output devices (e.g., one or more loudspeakers), and/or one or more haptic output devices (e.g., one or more devices that are configured to generate vibratory output). For example, the one or more output devices 326 can comprise a touch sensitive display that is used to output an interface (e.g., a user interface) that can be configured to display indications based on the schema data 303, the content data 304, and/or the attribute data 305.

The one or more sensors 328 can comprise one or more LiDAR devices, one or more sonar devices, one or more radar devices, one or more accelerometers, one or more gyroscopes, one or more altimeters, and/or one or more temperature sensors (e.g., one or more thermometers). The one or more input devices 330 can include one or more keyboards, one or more touch sensitive devices (e.g., a touch screen display), one or more buttons (e.g., a power button and/or volume buttons), one or more microphones, and/or one or more imaging devices (e.g., one or more cameras).

The one or more memory devices 302 and the one or more mass storage devices 324 are illustrated separately, however, the one or more memory devices 302 and the one or more mass storage devices 324 can be regions within the same memory module. The computing device 300 can include one or more additional processors, memory devices, and/or network interfaces, which can be provided separately or on the same chip or board. The one or more memory devices 302 and the one or more mass storage devices 324 can include one or more computer-readable media, including, but not limited to, non-transitory computer-readable media, RAM, ROM, hard drives, flash drives, and/or other memory devices.

The one or more memory devices 302 can store sets of instructions for applications including an operating system that can be associated with various software applications or data. For example, the one or more memory devices 302 can store sets of instructions for applications that can generate output including the attribute data 305. The one or more memory devices 302 can be used to operate various applications including a mobile operating system developed specifically for mobile devices. As such, the one or more memory devices 302 can store instructions that allow the software applications to access data including data associated with the determination of schemas, processing of content data, and/or the generation of attribute data. In other embodiments, the one or more memory devices 302 can be used to operate or execute a general-purpose operating system that operates on both mobile and stationary devices, including for example, smartphones, laptop computing devices, tablet computing devices, and/or desktop computers.

The software applications that can be operated or executed by the computing device 300 can include applications associated with the system 100 shown in FIG. 14. Further, the software applications that can be operated and/or executed by the computing device 300 can include native applications and/or web-based applications.

The location device 332 can include one or more devices or circuitry for determining the position of the computing device 300. For example, the location device 332 can determine an actual and/or relative position of the computing device 300 by using a satellite navigation positioning system (e.g., a GPS system, a Galileo positioning system, the GLObal Navigation satellite system (GLONASS), and/or the BeiDou Satellite Navigation and Positioning system), an inertial navigation system, a dead reckoning system, based on IP address, by using triangulation and/or proximity to cellular towers and/or Wi-Fi hotspots.

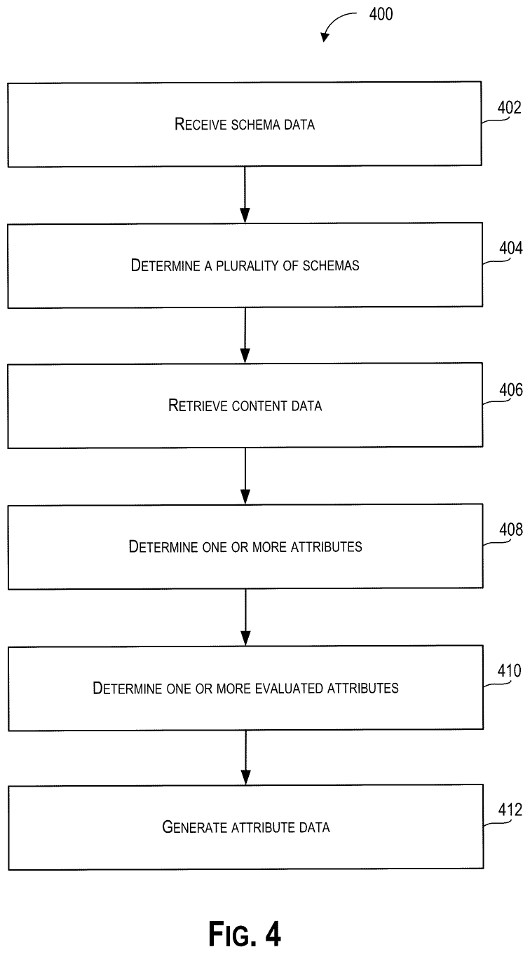

FIG. 4 depicts a flow chart diagram of an example method of determining schemas and generating attribute data associated with geographic locations according to example embodiments of the present disclosure. One or more portions of the method 400 can be executed and/or implemented on one or more computing devices or computing systems comprising, for example, the computing device 50, the server computing system 60, the model development platform system 70, and/or the computing device 300. Further, one or more portions of the method 400 can be executed or implemented as an algorithm on the hardware devices or systems disclosed herein. FIG. 4 depicts steps performed in a particular order for purposes of illustration and discussion. Those of ordinary skill in the art, using the disclosures provided herein, will understand that various steps of any of the methods disclosed herein can be adapted, modified, rearranged, omitted, and/or expanded without deviating from the scope of the present disclosure.

At 402, the method 400 can include receiving schema data comprising web content and/or a plurality of queries. For example, the computing device 50 can receive schema data comprising search query logs. The schema data can be received from a local device (e.g., a repository of search query logs stored on a storage device of the server computing system 60) and/or from a remote source (e.g., a remote computing system) via a network such as the network 49.

At 404, the method 400 can include determining, based on inputting the schema data into one or more machine-learned models, a plurality of schemas that comprise attributes associated with geographic locations associated with the schema data. The one or more machine-learned models can be configured and/or trained to determine the plurality of schemas based on detection, recognition, and/or classification of one or more semantic features of the schema data. For example, the server computing system 60 can implement one or more machine-learned models (e.g., the one or more machine-learned models 65), that can receive input comprising the schema data. Based on processing the schema data, the one or more machine-learned models can generate the plurality of schemas that comprise attributes associated with geographic locations associated with the schema data.

At 406, the method 400 can include retrieving, based on inputting the plurality of schemas into the one or more machine-learned models, content data comprising content from one or more content sources. For example, the server computing system 60 can implement one or more machine-learned models (e.g., the one or more machine-learned models 65), that can receive input comprising the plurality of schemas. Based on processing plurality of schemas, the one or more machine-learned models can retrieve content data that is associated with the plurality of schemas from one or more content sources (e.g., one or more web pages).

At 408, the method 400 can include determining, based on inputting the content data and the plurality of schemas into the one or more machine-learned models, one or more attributes associated with a plurality of content verticals of the content data. For example, the server computing system 60 can implement one or more machine-learned models (e.g., the one or more machine-learned models 65), that can receive input comprising the content data and the plurality of schemas and based on processing the content data to determine the content data that is associated with the plurality of schemas, generate output comprising the one or more attributes associated with the plurality of content verticals of the content data (e.g., content verticals associated with attributes of geographic locations indicated in the content data).

At 410, the method 400 can include determining, based on inputting the one or more attributes associated with the content data into the one or more machine-learned models, one or more evaluated attributes comprising the one or more attributes that satisfy one or more evaluation criteria associated with the validity of the one or more attributes. For example, the server computing system 60 can implement one or more machine-learned models (e.g., the one or more machine-learned models 65), that can receive input comprising the one or more attributes and based on processing the one or more attributes to determine whether the one or more attributes satisfy the one or more evaluation criteria, generate output comprising the one or more evaluated attributes.

At 412, the method 400 can include generating attribute data based on the one or more evaluated attributes. For example, the server computing system 60 can generate attribute data comprising a plurality of evaluated attributes associated with a name, telephone number, and specific amenities (e.g., kid friendly, pet friendly, and/or casual dress code) associated with a geographic location (e.g., a restaurant).

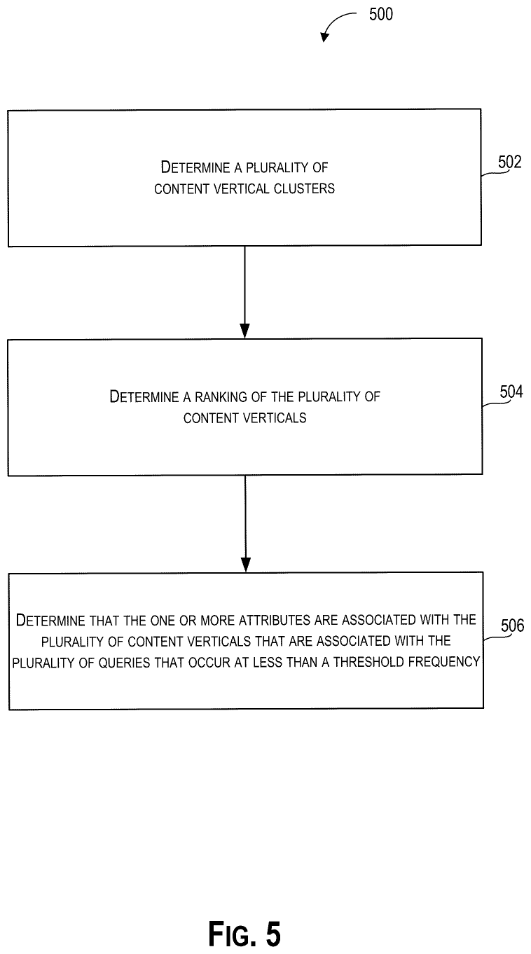

FIG. 5 depicts a flow chart diagram of an example method of determining schemas and generating attribute data associated with geographic locations according to example embodiments of the present disclosure. One or more portions of the method 500 can be executed and/or implemented on one or more computing devices or computing systems comprising, for example, the computing device 50, the server computing system 60, the model development platform system 70, and/or the computing device 300. Further, one or more portions of the method 500 can be executed or implemented as an algorithm on the hardware devices or systems disclosed herein. In some embodiments, one or more portions of the method 500 can be performed as part of the method 400 that is described with respect to FIG. 4. FIG. 5 depicts steps performed in a particular order for purposes of illustration and discussion. Those of ordinary skill in the art, using the disclosures provided herein, will understand that various steps of any of the methods disclosed herein can be adapted, modified, rearranged, omitted, and/or expanded without deviating from the scope of the present disclosure.

At 502, the method 500 can include determining a plurality of content vertical clusters based on a plurality of queries associated with each content vertical of the plurality of content verticals. For example, the server computing system 60 can implement a machine-learned model that is configured and/or trained to receive the plurality of queries and generate a plurality of content vertical clusters based on the plurality of queries.

At 504, the method 500 can include determining a ranking of the plurality of content vertical clusters based on a frequency of the plurality of queries associated with each content vertical of the plurality of content verticals. For example, the server computing system 60 can rank the plurality of content vertical clusters from most frequently occurring vertical clusters to the least frequently occurring vertical clusters.

At 506, the method 500 can include determining that the one or more attributes are associated with the plurality of content verticals that are associated with the plurality of queries that occur at less than a threshold frequency. For example, based on a threshold frequency of the bottom quintile, the server computing system 60 can determine that the one or more attributes are associated with the plurality of content vertical clusters that are in the bottom quintile of the frequency distribution of the plurality of content vertical clusters.

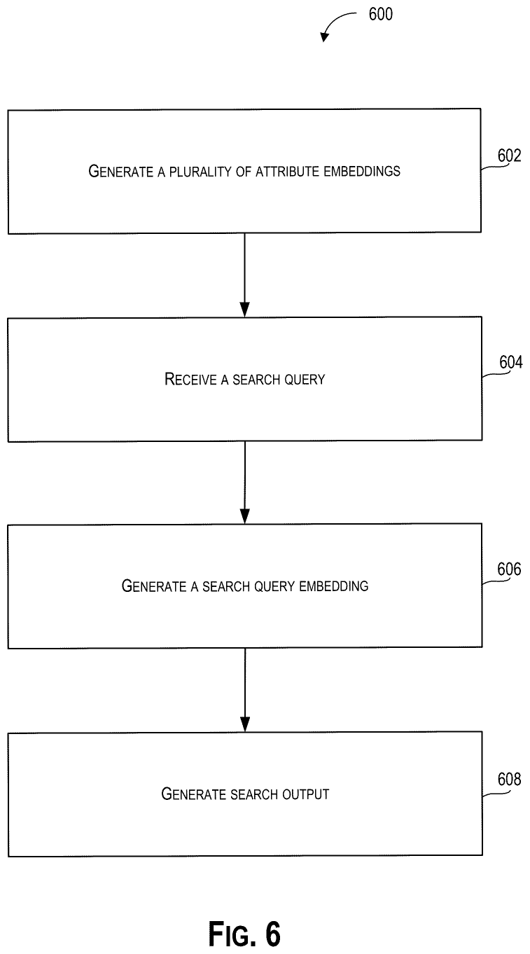

FIG. 6 depicts a flow chart diagram of an example method of determining schemas and generating attribute data associated with geographic locations according to example embodiments of the present disclosure. One or more portions of the method 600 can be executed and/or implemented on one or more computing devices or computing systems comprising, for example, the computing device 50, the server computing system 60, the model development platform system 70, and/or the computing device 300. Further, one or more portions of the method 600 can be executed or implemented as an algorithm on the hardware devices or systems disclosed herein. In some embodiments, one or more portions of the method 600 can be performed as part of the method 400 that is described with respect to FIG. 4. FIG. 6 depicts steps performed in a particular order for purposes of illustration and discussion. Those of ordinary skill in the art, using the disclosures provided herein, will understand that various steps of any of the methods disclosed herein can be adapted, modified, rearranged, omitted, and/or expanded without deviating from the scope of the present disclosure.

At 602, the method 600 can include generating, based on inputting the attribute data into the one or more machine-learned models, a plurality of attribute embeddings associated with the attribute data. For example, the server computing system 60 can implement one or more machine-learned models (e.g., the one or more machine-learned models 65), which can receive input comprising the attribute data and generate output comprising the plurality of attribute embeddings.

At 604, the method 600 can include receiving a search query. The search query can be associated with a map application (e.g., a search query associated with finding a restaurant or a petting zoo) and/or a search application (e.g., a search for a hotel with certain amenities). For example, the computing device 50 can receive data comprising the search query (e.g., a search query associated with search for a restaurant that can be inputted into a navigation application and/or search application). The search query can be received from a local device (e.g., search query input via an onscreen keyboard of the computing device 50) and/or from a remote source (e.g., a remote computing system) via a network such as the network 49.

At 606, the method 600 can include generating a search query embedding based on the search query. For example, the server computing system 60 can implement one or more machine-learned models that are configured and/or trained to generate a search query embedding based on input comprising a search query (e.g., a text-based search query associated with determining the amenities at a concert hall).

At 608, the method 600 can include generating, based on comparing the search query embedding to the plurality of attribute embeddings, search output based on one or more portions of the attribute data associated with the search query. For example, the server computing system 60 can perform operations to determine the plurality of video relevance scores based on comparing the search query embedding to the plurality of video embeddings. For example, the server computing system 60 can perform one or more operations to compare the search query embedding to the plurality of attribute embeddings and determine the attribute embedding that is within a predetermined range of similarity with respect to the search query embedding (e.g., the attribute embedding that most closely matches the search query embedding). In some embodiments, the server computing system 60 can generate an interface (e.g., a graphical user interface) that can be displayed on a display component of a computing device that receives the search output. For example, the search output can comprise search results that are displayed in a user interface for a search application and/or map application.

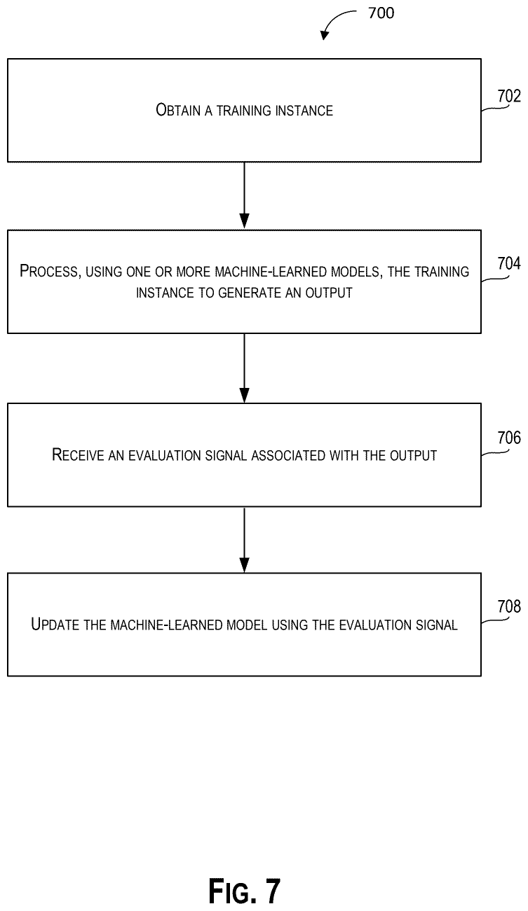

FIG. 7 depicts a flowchart of a method for training one or more machine-learned models according to aspects of the present disclosure. For instance, an example machine-learned model can include an attribute generation model that is configured and/or trained to generate attributes associated with geographic locations.

One or more portion(s) of example method 700 can be implemented by a computing system that includes one or more computing devices such as, for example, computing systems described with reference to the other figures. Each respective portion of example method 700 can be performed by any (or any combination) of one or more computing devices. Moreover, one or more portion(s) of example method 700 can be implemented on the hardware components of the device(s) described herein, for example, to train one or more systems or models. FIG. 7 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 7 is described with reference to elements/terms described with respect to other systems and figures for exemplary illustrated purposes and is not meant to be limiting. One or more portions of example method 700 can be performed additionally, or alternatively, by other systems.

At 702, example method 700 can include obtaining a training instance. A set of training data can include a plurality of training instances divided between multiple datasets (e.g., a training dataset, a validation dataset, or testing dataset). A training instance can be labeled or unlabeled. Although referred to in example method 700 as a “training” instance, it is to be understood that runtime inferences can form training instances when a model is trained using an evaluation of the model's performance on that runtime instance (e.g., online training/learning). Example data types for the training instance and various tasks associated therewith are described throughout the present disclosure.

At 704, example method 700 can include processing, using one or more machine-learned models, the training instance to generate an output. The output can be directly obtained from the one or more machine-learned models or can be a downstream result of a chain of processing operations that includes an output of the one or more machine-learned models.

At 706, example method 700 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi- or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

At 708, example method 700 can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 700 can include implementing a number of generalization techniques (e.g., weight decays, dropouts, etc.) to improve the generalization capability of the models being trained.

In some implementations, example method 700 can be implemented for training a machine-learned model from an initialized state to a fully trained state (e.g., when the model exhibits a desired performance profile, such as based on accuracy, precision, recall, etc.).

In some implementations, example method 700 can be implemented for particular stages of a training procedure. For instance, in some implementations, example method 700 can be implemented for pre-training a machine-learned model. Pre-training can include, for instance, large-scale training over potentially noisy data to achieve a broad base of performance levels across a variety of tasks/data types.

In some implementations, the example method 700 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). In some implementations, example method 700 uses adapter modules. Adapters can be small trainable layers that are inserted between pre-existing layers of a pre-trained model. During the fine-tuning process, the original parameters of the pre-trained model are typically frozen, and only the parameters of the adapters are updated.

In some implementations, example method 700 can be implemented to execute parameter-efficient fine-tuning methods, such as Layerwise Optimization of Residuals (LoRA). LoRA can refine pre-trained models with minimal adjustments to the original parameters. This can be achieved by introducing trainable low-rank matrices that modify the behavior of the pre-trained weights without directly altering them. In some implementations, during fine-tuning, only these auxiliary matrices are updated, which significantly reduces the number of parameters that are trained.

An example fine-tuning approach includes reinforcement learning. Reinforcement learning can be based on user feedback on model performance during use.

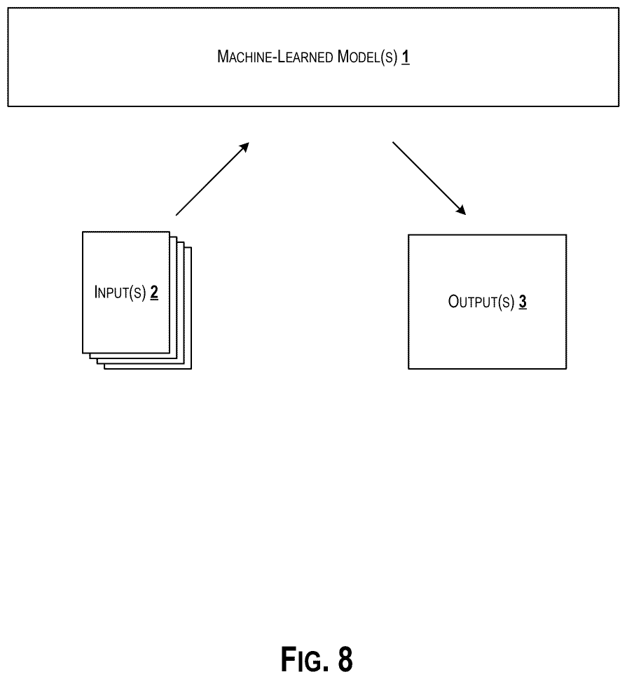

FIG. 8 is a block diagram of an example processing flow for using machine-learned model(s) 1 to process input(s) 2 to generate output(s) 3.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Machine-learned model(s) 1 can be or include, or otherwise be representative of any one or more of the machine-learned models described above with respect to the preceding figures. For example, machine-learned model(s) 1 can be or include, or otherwise be representative of any one or more of [list models described above], etc. Although various features, variations, and implementations described below are described with respect to machine-learned model(s) 1, it is to be understood that such features, variations, and implementations are to be understood as described with respect to each of [list models described above], etc., any other machine-learned component described herein.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) 1 can include a single or multiple instances of the same model configured to operate on data from input(s) 2. Machine-learned model(s) 1 can include multiple different models or multiple different model portions configured to operate on data from input(s) 2.

Machine-learned model(s) 1 can include an ensemble of different models that can cooperatively interact to process data from input(s) 2. For example, a model ensemble can include multiple models that have different attributes (e.g., different architectures, trained with different recipes, etc.). The ensemble can output an overall output based on the individual outputs of the constituent models. In this manner, for instance, the diverse constituent models can work together to provide system-level robustness by effectively aggregating over individual strengths and weaknesses of any given model. The respective individual outputs can be combined in a weighted combination, using a voting or routing mechanism, or a learned output layer (e.g., one or more feedforward or fully-connected layers).

Machine-learned model(s) 1 can employ a mixture-of-experts structure. See, e.g., Zhou et al., Mixture-of-Experts with Expert Choice Routing, arXiv:2202.09368v2 (Oct. 14, 2022). For example, different portions of a model can learn (explicitly or implicitly) different expertise areas, with pathways through the model being selected by a learned routing mechanism that engages the appropriate expert for a given input (e.g., a given portion of an input, such as on a per-token basis). For example, a feedforward network can be sparsely activated for a given portion of an input based on an output of a routing mechanism that processes the portion of the input. In this manner, for instance, the group of activated weights can form an “expert” that is selected by the router. On each forward pass, only a subset of the total model weights may be engaged, thereby decreasing a quantity of operations performed for processing a given input compared to a densely activated model. In this manner, for instance, the expressive and interpretive power of a high-parameter-count model can be achieved with more compute-efficient forward passes.

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

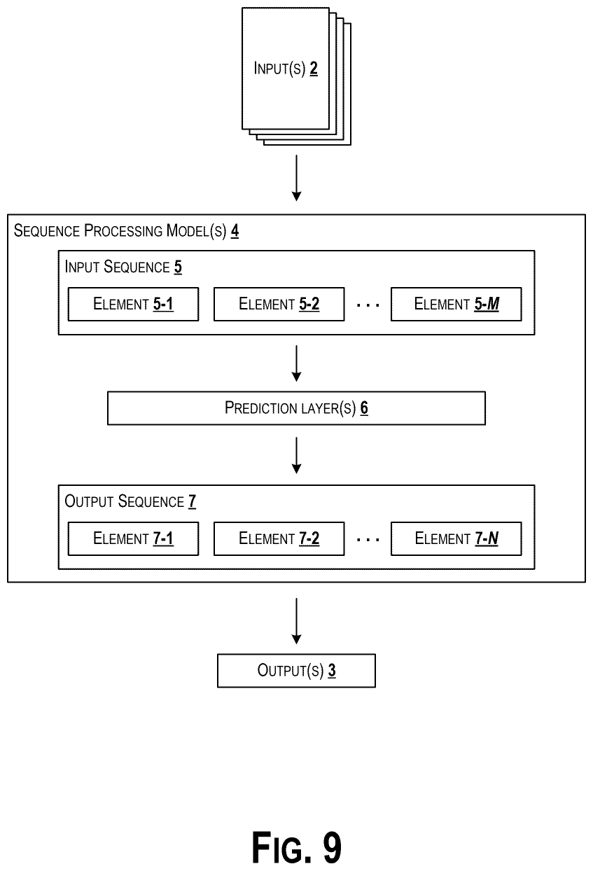

FIG. 9 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2, . . . , 5-M, etc. obtained from input(s) 2. Sequence processing model 4 can process input sequence 5 using prediction layer(s) 6 to generate an output sequence 7. Output sequence 7 can include one or more output elements 7-1, 7-2, . . . , 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models are referred to as language models and can leverage language-based understandings across one or multiple modalities of input information. Sequence processing model(s) 4 can include relatively large models (e.g., more parameters, computationally expensive, etc.), which may be referred to as “Large Language Models” or LLMs. Sequence processing model(s) 4 can include relatively small models (e.g., fewer parameters, computationally lightweight, etc.), which may be referred to as “Small Language Models” or SLMs. Example language models include, for instance, models described in Gemma: Open Models Based on Gemini Research and Technology, Google; and/or Gemma 2: Improving Open Language Models at a Practical Size, Google.

Sequence processing model(s) 4 can process one or multiple types of data simultaneously. Variations of language models that can perform joint vision and language tasks may be referred to as “Vision-Language Models,” or VLMs. Example VLMs include models described in PaliGemma: A versatile 3B VLM for transfer, Google; PaliGemma 2: A Family of Versatile VLMs for Transfer, Google; Flamingo: a Visual Language Model for Few-Shot Learning, Google; and/or PaLI: A Jointly-Scaled Multilingual Language-Image Model, Google.

Sequence processing model(s) 4 can be multimodal. Example multimodal sequence processing models include, for instance, models described in Gemini: A Family of Highly Capable Multimodal Models, Google; Gemini 1.5: Unlocking multimodal understanding across millions of tokens of context, Google.

Other example sequence processing models can operate to generate outputs or receive inputs in specific domains, such as image domains, see, e.g., Dosovitskiy et al., An Image is Worth 16×16 Words: Transformers for Image Recognition at Scale, arXiv:2010.11929v2 (Jun. 3, 2021), audio domains, see, e.g., Agostinelli et al., MusicLM: Generating Music From Text, arXiv:2301.11325v1 (Jan. 26, 2023), biochemical domains, see, e.g., Jumper et al., Highly accurate protein structure prediction with AlphaFold, 596 Nature 583 (Aug. 26, 2021), by way of example.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . , 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . , 5-M can represent tokens obtained using a tokenizer. For instance, a tokenizer can process a given portion of an input source and output a series of tokens (e.g., corresponding to input elements 5-1, 5-2, . . . , 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, Proceedings of the 2018 Conference on Empirical Methods in Natural Language Processing (System Demonstrations), pages 66-71 (Oct. 31-Nov. 4, 2018). Image-based input source(s) can be tokenized by extracting and serializing patches from an image.

In general, arbitrary data types can be serialized and processed into input sequence 5. It is to be understood that element(s) 5-1, 5-2, . . . , 5-M depicted in FIG. 9 can be the tokens or can be the embedded representations thereof.

Prediction layer(s) 6 can predict one or more output elements 7-1, 7-2, . . . , 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter's toolbox was small and heavy. It was full of ___.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 4. See, e.g., Vaswani et al., Attention Is All You Need, arXiv:1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, arXiv:2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

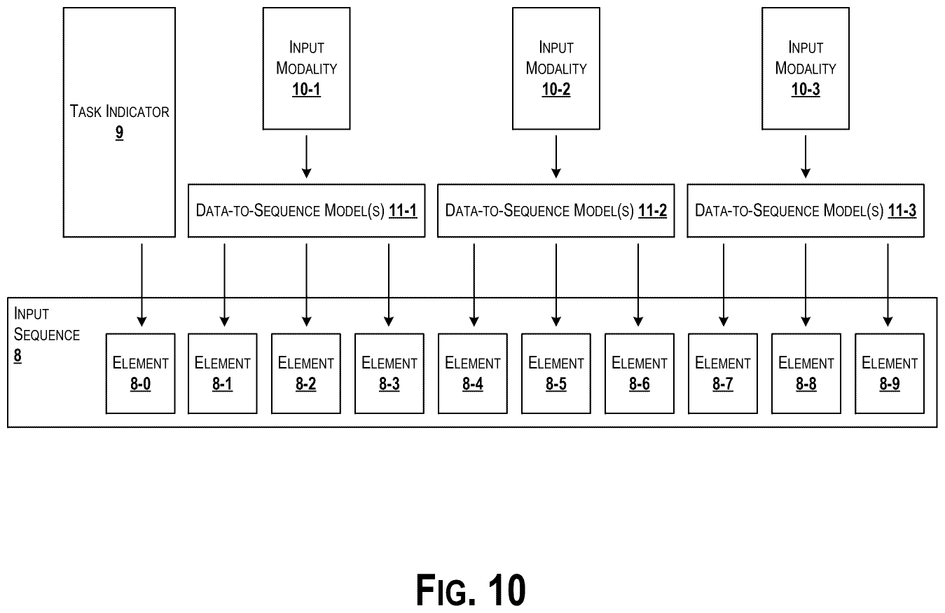

FIG. 10 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary data type data-to-sequence model can subdivide an input of that arbitrary data type and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

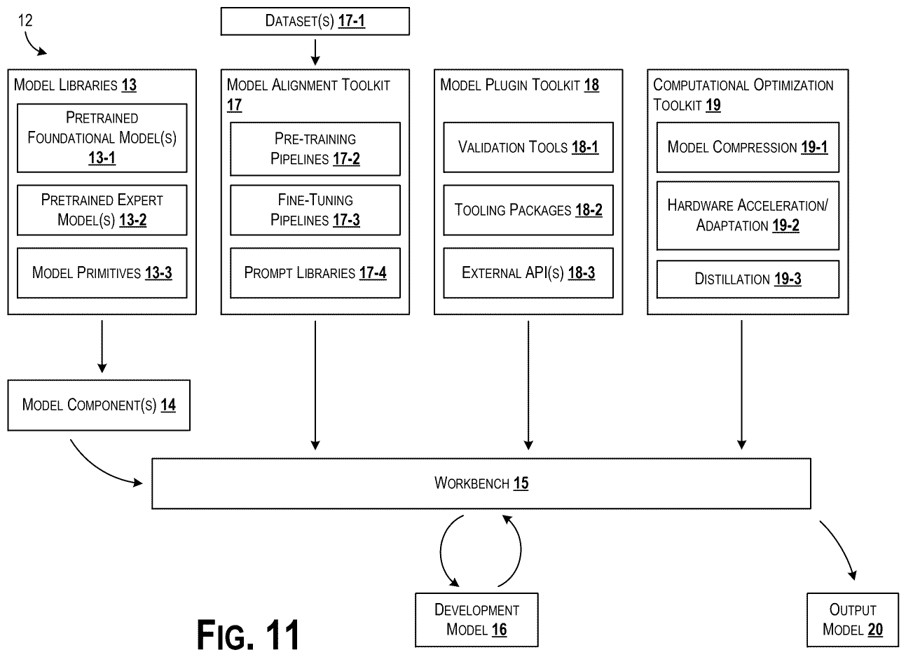

FIG. 11 is a block diagram of an example model development platform 12 that can facilitate creation, adaptation, and refinement of example machine-learned models (e.g., machine-learned model(s) 1, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired. Model primitives 13-3 can include a library of pre-trained adapters or LoRA modules that can adapt a baseline foundational model to align its outputs with a desired performance profile, augment model capabilities (e.g., to adapt to a different input modality, etc.), and the like.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing the accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based on one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output an input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training method 700 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models—e.g., understanding an intent in an unstructured request for a task—while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instructions that initiate API calls to send or obtain data via external systems.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

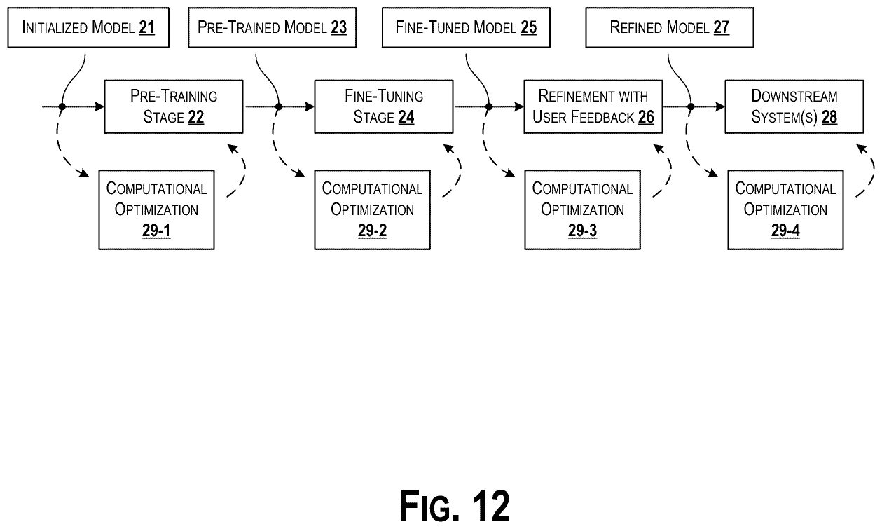

FIG. 12 is a block diagram of an example training flow for training a machine-learned development model 16. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 12 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 12 is described with reference to elements/terms described with respect to other systems and figures for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model has satisfactory performance, if the model was already fine-tuned, or if other tuning approaches are preferred.

Fine-tuned model 29 can then be a new version of development model 16, which can persist as development model 16 or as a new development model. Fine-tuned model 29 can be the initial state if development model 16 was already fine-tuned. Fine-tuned model 29 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1, . . . , 29-4 can all be the same, all be different, or include at least some different optimization techniques.

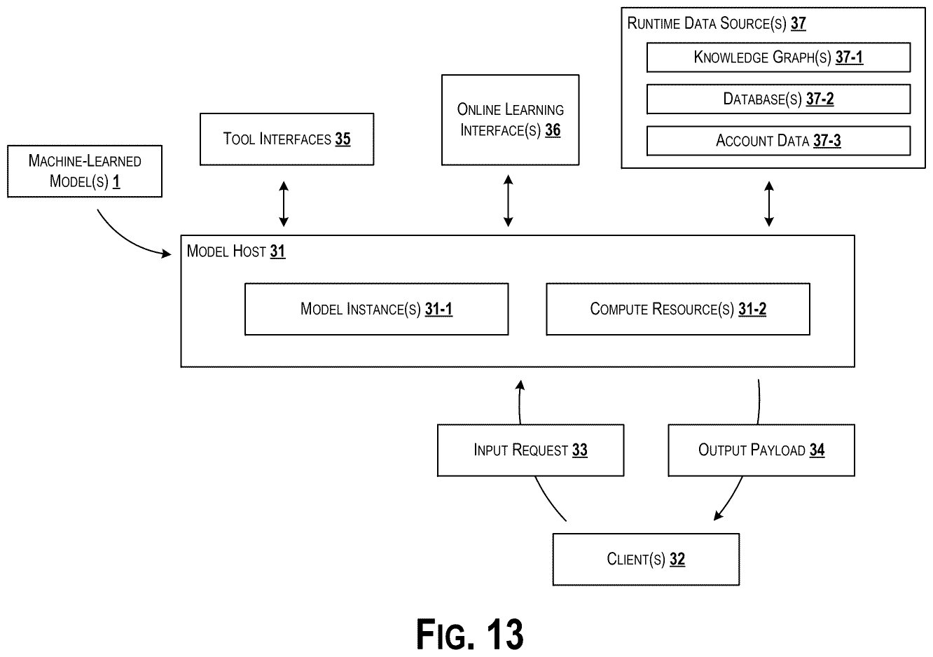

FIG. 13 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) 2 can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on the same device or system as client(s) 32. Model host 31 can be a machine-learning service that runs on-device to provide machine-learning functionality to one or multiple applications operating on a client device, which can include an application implementing client(s) 32. Model host 31 can be a part of the same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also shard model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLHF). Online learning interface(s) 36 can facilitate federated learning of machine-learned model(s) 1.

Model host 31 can access a library of pre-trained adapters or LoRA modules that can adapt a baseline model to align its outputs with a desired performance profile, augment model capabilities (e.g., to adapt to a different input modality, etc.), and the like. For instance, model host 31 can receive an input request to load a customized model, and model host 31 can retrieve one or more components to adapt a baseline model to the custom profile. Model host 31 can determine that a particular functionality is needed for a particular task (e.g., based on an output of a model that preprocesses an input) and retrieve a pre-trained component accordingly.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output. As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) 1 can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data). In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For instance, machine-learned model(s) 1 can be configured to generate output(s) 3 to complete a sentence, paragraph, or portion of text that follows from a portion of text represented by input(s) 2.

In some implementations, the task can be an instruction-following task. Machine-learned model(s) 1 can be configured to process input(s) 2 that represent instructions to perform a function and to generate output(s) 3 that advance a goal of satisfying the instruction function (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

FIG. 14 is a block diagram of an example networked computing system that can perform aspects of example implementations of the present disclosure. The system can include a number of computing devices and systems that are communicatively coupled over a network 49. An example computing device 50 is described to provide an example of a computing device that can perform any aspect of the present disclosure (e.g., implementing model host 31, client(s) 32, or both). An example server computing system 60 is described as an example of a server computing system that can perform any aspect of the present disclosure (e.g., implementing model host 31, client(s) 32, or both). Computing device 50 and server computing system(s) 60 can cooperatively interact (e.g., over network 49) to perform any aspect of the present disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the present disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 14 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who may use another computing device to interact with computing device 50).

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1, such as a sequence processing model 4. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model 4. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and/or combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 4, 16, 20, 55, 65, etc. (e.g., third-party resource(s) 85).

FIG. 14 illustrates one example arrangement of computing systems that can be used to implement the present disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

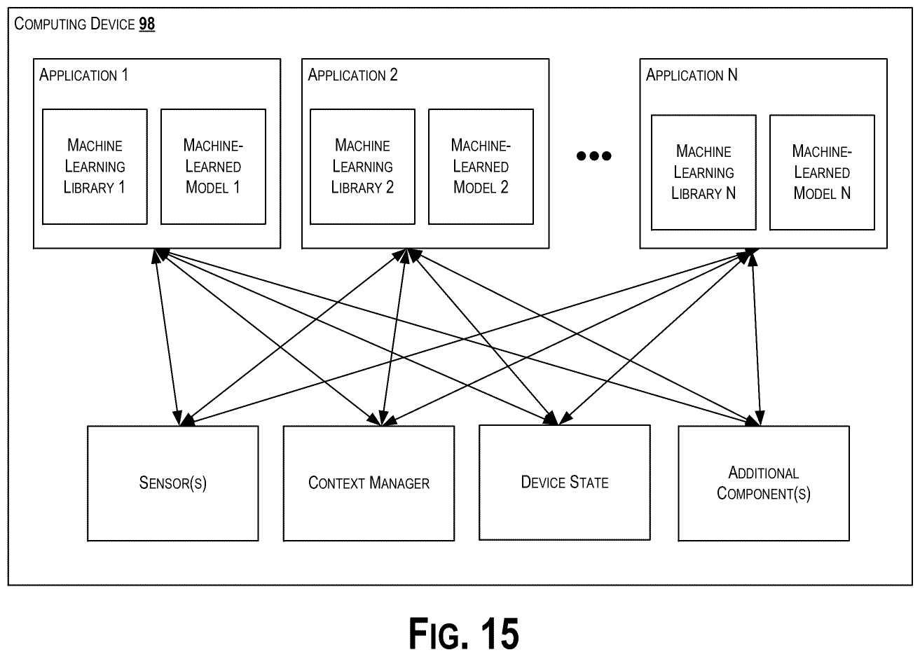

FIG. 15 is a block diagram of an example computing device 98 that performs according to example embodiments of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. As illustrated in FIG. 15, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

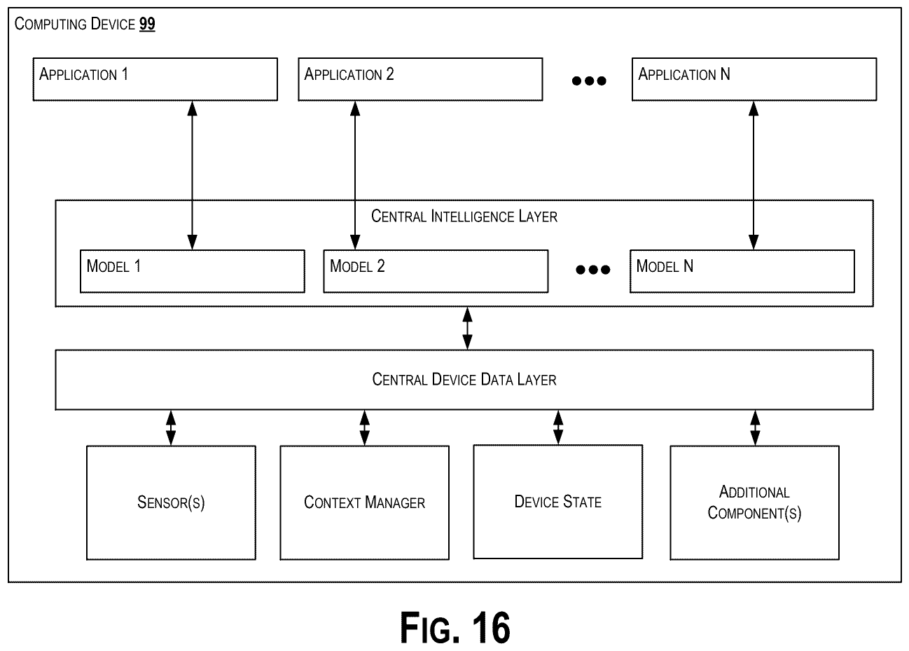

FIG. 16 is a block diagram of an example computing device 99 that performs according to example embodiments of the present disclosure. The computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 16, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 16, the central device data layer can communicate with a number of other components of the computing device, such as, for example, one or more sensors, a context manager, a device state component, or additional components. In some implementations, the central device data layer can communicate with each device component using an API (e.g., a private API).

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure covers such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

What is claimed is:

1. A computer-implemented method of processing content, the computer-implemented method comprising:
receiving, by a computing system comprising one or more processors, schema data comprising web content and a plurality of queries;
determining, by the computing system, based on inputting the schema data into one or more machine-learned models, a plurality of schemas comprising one or more attributes of geographic locations associated with the schema data, wherein the one or more machine-learned models are configured to determine the plurality of schemas based on recognition of one or more semantic features of the schema data;
retrieving, by the computing system, based on inputting the plurality of schemas into the one or more machine-learned models, content data comprising content from one or more content sources;
determining, by the computing system, based on inputting the content data and the plurality of schemas into the one or more machine-learned models, the one or more attributes associated with a plurality of content verticals of the content data;
determining, by the computing system, based on inputting the one or more attributes associated with the content data into the one or more machine-learned models, one or more evaluated attributes comprising the one or more attributes that satisfy one or more evaluation criteria associated with a validity of the one or more attributes; and
generating, by the computing system, attribute data based on the one or more evaluated attributes.

2. The computer-implemented method of claim 1, wherein the one or more machine-learned models comprise one or more prompt generation models that are configured to generate one or more prompts to determine whether an attribute of the one or more attributes is associated with one or more portions of the content, and wherein the one or more attributes are generated based on inputting the one or more prompts into the one or more machine-learned models.

3. The computer-implemented method of claim 2, wherein the one or more prompts are configured to elicit a Boolean type of response that indicates whether the attribute indicated in each prompt is associated with one or more portions of content indicated in the prompt.

4. The computer-implemented method of claim 1, wherein the one or more content sources comprise a plurality of web pages, and wherein the one or more machine-learned models are configured to scrape the content data from the one or more content sources comprising the plurality of web pages.

5. The computer-implemented method of claim 1, wherein the plurality of content verticals are associated with a plurality of classes of establishments or a plurality of classes of locations.

6. The computer-implemented method of claim 5, wherein the plurality of classes of establishments comprise hotels, restaurants, stores, shopping centers, fitness centers, gas stations, charging stations, amusement parks, campgrounds, or medical centers.

7. The computer-implemented method of claim 1, wherein the plurality of schemas correspond to the plurality of content verticals.

8. The computer-implemented method of claim 1, further comprising:
determining, by the computing system, a plurality of content vertical clusters based on the plurality of queries associated with each content vertical of the plurality of content verticals;
determining, by the computing system, a ranking of the plurality of content vertical clusters based on a frequency of the plurality of queries associated with each content vertical cluster of the plurality of content vertical clusters; and
determining, by the computing system, that the one or more attributes are associated with the plurality of content vertical clusters that are associated with the plurality of queries that occur at less than a threshold frequency.

9. The computer-implemented method of claim 1, further comprising:
generating, by the computing system, based on inputting the attribute data into the one or more machine-learned models, a plurality of attribute embeddings associated with the attribute data;
receiving, by the computing system, a search query;
generating, by the computing system, a search query embedding based on the search query; and
generating, by the computing system, based on comparing the search query embedding to the plurality of attribute embeddings, search output based on one or more portions of the attribute data associated with the search query.

10. The computer-implemented method of claim 1, wherein the one or more evaluation criteria comprise one or more relevance criteria associated with a relevance of the one or more attributes with respect to the plurality of content verticals.

11. The computer-implemented method of claim 1, wherein the schema data or the content data comprise user generated content or a plurality of web pages, and wherein the user generated content comprises one or more images, one or more text segments, one or more audio segments, or one or more video segments.

12. The computer-implemented method of claim 11, wherein the user generated content comprises a plurality of user reviews.

13. The computer-implemented method of claim 11, wherein the plurality of web pages comprise a plurality of aggregator web site pages or a plurality of authority web site pages.

14. The computer-implemented method of claim 1, wherein the one or more machine-learned models comprise one or more large language models.

15. One or more tangible non-transitory computer-readable media storing computer-readable instructions that when executed by one or more processors cause the one or more processors to perform operations, the operations comprising:
receiving schema data comprising web content and a plurality of queries;
determining, based on inputting the schema data into one or more machine-learned models, a plurality of schemas comprising one or more attributes of geographic locations associated with the schema data, wherein the one or more machine-learned models are configured to determine the plurality of schemas based on recognition of one or more semantic features of the schema data;
retrieving, based on inputting the plurality of schemas into the one or more machine-learned models, content data comprising content from one or more content sources;
determining, based on inputting the content data and the plurality of schemas into the one or more machine-learned models, the one or more attributes associated with a plurality of content verticals of the content data;
determining, based on inputting the one or more attributes associated with the content data into the one or more machine-learned models, one or more evaluated attributes comprising the one or more attributes that satisfy one or more evaluation criteria associated with a validity of the one or more attributes; and
generating attribute data based on the one or more evaluated attributes.

16. The one or more tangible non-transitory computer-readable media of claim 15, wherein the one or more machine-learned models comprise one or more prompt generation models that are configured to generate one or more prompts to determine whether an attribute of the one or more attributes is associated with one or more portions of the content, and wherein the one or more attributes are generated based on inputting the one or more prompts into the one or more machine-learned models.

17. The one or more tangible non-transitory computer-readable media of claim 15, wherein the plurality of content verticals are associated with a plurality of classes of establishments or a plurality of classes of locations.

18. A computing system comprising:
one or more processors;
one or more non-transitory computer-readable media storing instructions that when executed by the one or more processors cause the one or more processors to perform operations comprising:
receiving schema data comprising web content and a plurality of queries;
determining, based on inputting the schema data into one or more machine-learned models, a plurality of schemas comprising one or more attributes of geographic locations associated with the schema data, wherein the one or more machine-learned models are configured to determine the plurality of schemas based on recognition of one or more semantic features of the schema data;
retrieving, based on inputting the plurality of schemas into the one or more machine-learned models, content data comprising content from one or more content sources;
determining, based on inputting the content data and the plurality of schemas into the one or more machine-learned models, the one or more attributes associated with a plurality of content verticals of the content data;
determining, based on inputting the one or more attributes associated with the content data into the one or more machine-learned models, one or more evaluated attributes comprising the one or more attributes that satisfy one or more evaluation criteria associated with a validity of the one or more attributes; and
generating attribute data based on the one or more evaluated attributes.

19. The computing system of claim 18, wherein the one or more machine-learned models comprise one or more prompt generation models that are configured to generate one or more prompts to determine whether an attribute of the one or more attributes is associated with one or more portions of the content, and wherein the one or more attributes are generated based on inputting the one or more prompts into the one or more machine-learned models.

20. The computing system of claim 18, wherein the plurality of content verticals are associated with a plurality of classes of establishments or a plurality of classes of locations.
